(19) United States
(12) Patent Application Publication
(10) Pub. No.: US 2007/0172809 A1
(43) Pub. Date: Jul. 26, 2007

(54) META-DATA AND METRICS BASED LEARNING

(76) Inventor: Anshu Gupta, North Andover, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/626,600

(22) Filed: Jan. 24, 2007

Related U.S. Application Data
(60) Provisional application No. 60/761,682, filed on Jan. 24, 2006.

(51) Int. Cl. G09B 3/00

(52) U.S. Cl. 434/350; 434/322; 434/362

(57) ABSTRACT

The invention relates generally to a system and methodology for learning, and in particular for practicing for tests. The system and method employs algorithms for performing various analytics. A computerized system analyzes Meta-Data associated with the Tests, Questions and the learner/student response to those and provides information which helps the learner/student learn faster, get a deeper understanding of the subject area and helps them focus and practice for the subject area of needs. As the data for a student is collected the system can analyze the core strength and weakness of student for the subject, topic or subtopic etc. and in various other dimensions. Additionally as data from multiple students is aggregated the methodology defines the mechanism to analyze and quantify the outcome from three areas of learning namely, the learner effort, an instructor effort and the quality of learning contents. Such a meta-data based learning methodology greatly reduces the potential for guess and subjective analysis and improves the learning of an individual based on the quantifiable data, either at the user choice or being driven by the system recommendation.

### CROSS-REFERENCE TO RELATED APPLICATIONS

This application is related to and claims priority from U.S. provisional Application No. 60/761,682 filed Jan. 24, 2006 entitled Practice and Metrics Based Learning, which is incorporated fully herein by reference.

### TECHNICAL FIELD

The present invention relates to learning systems and associated methodologies and more particularly, to a system and method for objectively evaluating and quantifying the learning, intelligence and intelligence types of learner (students), for providing analysis and recommendation of strategies and content to improve and speed up the process of learning for learners; for providing analysis and quantifying the impact of various aspects (instructor, books, environment etc.) that are involved in the teaching and learning process; and for providing recommendations to improve the various aspects involved in the teaching and learning process.

### BACKGROUND INFORMATION

During the learning process, various components play important role. The fundamental components of learning includes; first and foremost the learner (student)—their involvement, willingness and participation. The second is the content that is utilized for learning. Finally the delivery mechanism, which can be a face to face instructor, virtual class room or via any other means.

The existing process of teaching and learning involves; understand and develop theoretical concepts, optionally see and experiment with some working examples, optimally practice and absorbing of knowledge by students and then assessing student by means of ‘Quizzes’. ‘Tests’ or ‘Exams’. Based on the assessment outcome, the teacher, instructor or student decides where to focus next. Example, the assessment outcome can be to read more theory, practice or see more examples, or practice more Quizzes.

This assessment process loop is utilized at various levels in all aspects of life. For example, in school quizzes, mid term or end of semester exams, standardize tests for college admission in United States like SAT (Scholastic Aptitude Test) for undergrad program, GRE (Graduate Record Exam) for graduate program. Outside of school they are used for evaluation of people in professional setting for certification or qualification—example, Series 7 certification test in financial industry and so on. These ‘Quizzes’, ‘Tests’ and ‘Exams’ are part of every person life.

Because of the need and growing importance of these ‘Tests’ in everyday life the learner (student) tries to get the best scores. There are various tools, strategies and methods that help student prepare for specific exams. Students appearing for these exams spend considerable effort to prepare and practice. Based on the outcome of practice test assessment they or their advisor (instructor, teacher, parents etc.) search and gather similar type of questions for problem topics scattered in various books, guides or other material and student practices more. These question gathering is tedious, time consuming and is generally based on few recent practice test outcome. Additionally these technique focuses mainly on the final score outcome of recent practice tests.

Today's learning, assessment and test preparation process is highly inefficient. Specifically: 1) Students waste a considerable percentage of their test preparation time studying and re-studying wrong material. 2) No personalized time (from elementary to college) trackable metrics exist on student's grasp of 100's of sub-topics within major subjects. 3) Enormous amount of valuable information is lost regarding sub-topic knowledge and understanding as students progresses in learning sessions. For example: For high school SAT exams, a student may spend 2-8 months practicing for this test. As the student is doing self testing on 100's of questions, there are number of scribbles he/she places on multiple choice questions as well as entertains several thoughts such as; “is this the right answer or this one”, or “this is too difficult for me”, “I don't understand this topic”, “I must review this before the exam day”, “I am done with this subtopic”, etc. Some of the scribble and thoughts offer rich information about grasp of the material than even knowing if the response was correct or incorrect. This rich information, known as ‘meta-data’, if captured in a structured way, analyzed, and processed can offer tremendous breakthrough in accelerated learning and comprehension.

Accordingly, a need exists to provide better information and more feedback and utilization of various learning methodologies and styles.

### SUMMARY

The invention described in this document relates generally to a methodology for learning in particular practicing for tests by learner (student), quantifying assessment of fundamental pillars of learning and making recommendations, named as Meta-Data and Metrics Based Learning (MMBL). MMBL methodology based solution allows easy capture of this ‘meta-data’ over time with minimal distraction to the student. This data is then processed and leveraged to generate highly focused practice session to meet the overall learning goals. For example a student can select to practice questions “which were easy but were answered incorrectly” or practice questions “related to weakest sub-topic in Math (e.g. volumetric concepts in solid objects)”.

Such a study tool offers huge benefits: (1) Student's master sub-topic in far less time; (2) Students study focus in not random or gut feel—MMBL optimally focuses the students based on the learning goals; and (3) Offers a methodical and customized learning plan as the student develops from early grades to post college based on student's natural ability—capabilities and motivation.

This ‘meta-data’ driven process eliminates inefficiencies and friction from the learning process. It starts saving significant percentage of learner time from initial session onward. The efficiency improves over time as the history of student knowledge builds up in the system.

Combining the user ‘Meta-Data’ with user feedback about content used and quality of instructor and, then analyzing this data over multiple users produces a good qualification and quantification of the content and quality of instructors. Thus the MMBL based solution supports and over the long term enhances the fundamental core components and pillars (student, content used and instructor) of learning.

According to the present invention, a learning method, collaboration and content creation mechanism, meta-data based assessment, analysis and recommendation algorithms, a data tracking method and a system are disclosed that helps improve the efficiency of fundamental components which are involved in the learning process.

Meta-data is defined as the data that describes other data. In this instance the ‘Other Data’ are the ‘Tests’ (‘Quizzes’, ‘Tests’ or ‘Exams’) or at more granular level are the ‘Questions’ which are part of the Tests. There are a lot of Meta-Data (attributes) associated with Tests and Questions. The attributes associated with Tests are called as ‘Test Meta Data’ (TMD). Attributes associated with Questions are referred to herein as ‘Question Meta Data’ (QMD). TMD and QMD is something that is associated with a Test and a Question for its entire life time. This meta-data can be tagged with the Test or Question at any time in its life cycle and will mostly remain static.

Whenever a student responds to the Question in a test, two other types of data come into picture. The first category is the response to the question, called as ‘Question Response Data’ (QRD), and the second category is the information about the thoughts in the Student's mind referred to herein as ‘Cognitive Meta Data’ (CMD). In addition, another critical information that is available is the amount of time spent on each Question by Learner/Student.

CMD is unique for each individual for each Question. This is time sensitive as well as learning intelligence and intelligence type sensitive. It changes as the Learner/Student conducts more practice and acquires more knowledge, this can even change as the leaner (student) practices the same test second time.

These various meta-data can be explained by mean of a sample Question in a Test. For example, in a Math Test for 10^{th} grade, a Question can be: If a circle has the diameter of 8, what is the circumference? Please select one of the following correct answers: (A)—6.28; (B)—12.56 (C)—25.13; (D)—50.24; (E)—110.48. The student responds to this question by marking answer (C) in one minute. The answer (C) is the correct answer.

There is a lot of meta-data that is tied with this Test (a collection of Questions) as a whole. Some of the example Test Meta-Data (TMD) for this Test includes but not limited to: Default grade for Test (value—10^{th} grade), Difficulty Level of Test (value—Medium), Subject of Test (value—Math), Section in Test (value—Geometry), Sub Section (value—Two dimensional objects), Objective of Test (values—Assess Memory Retention, Concept understanding), Exam Appeared (values—2004 final exam, 2002 final exam), Created by (value—Teacher XYZ), Dependent on (values—Algebra, Geometry) and so on.

Every Question has large amount of Meta-Data (attributes) associated with it. So the QMD type and corresponding values for the Question in above example is but not limited to this list are: Type of question (value—Multiple choice); Grade level (value—10^{th} grade), Subject (value—Math), Sub Topic (value —Geometry), Sub-Sub Topic (value—Circles), Expected Time to Solve (value—30 Sec), Objective of Question (values—Memory recall, concept application) and so on.

At a more detailed level, the QMD categories have very valuable information and context associated with them. A Few of them can be explained and described as below but not limited to this list are:

QUESTION KNOWLEDGE OBJECTIVE—This meta-data is associated with the Questions and Tests that lays out the knowledge objectives and utilizes different brain power. The categories as defined by Bloom, but are not limited to this list are:

KNOWLEDGE (values—Remembering, Memorizing, Recognizing, Recalling identification, Recalling information, who, what, when, where, how?);

COMPREHENSION (values—Interpreting, Translating from one medium to another, Describing in one's own words, Organization and selection of facts and ideas, Retell);

APPLICATION (Problem solving, Applying information to produce some result, Use of facts, rules and principles, How is . . . an example of . . . ?, How is . . . related to . . . ?, Why is . . . significant?);

ANALYSIS (Subdividing something to show how it is put together, Finding the underlying structure of a communication, Identifying motives, Separation of a whole into component parts, What are the parts or features of . . . ?, Classify . . . according to . . . , Outline/diagram . . . , How does . . . compare/contrast with . . . ?, What evidence can you list for . . . ?);

SYNTHESIS (Creating a unique, original product that may be in verbal form or may be a physical object, Combination of ideas to form a new whole, What would you predict/infer from . . . ?, What ideas can you add to . . . ?, How would you create/design a new . . . ?, What might happen if you combined . . . ?, What solutions would you suggest for . . . ?)

EVALUATION (values—Making value decisions about issues, Resolving controversies or differences of opinion, Development of opinions, judgments or decisions, Do you agree that . . . ? What do you think about . . . ? What is the most important . . . ? Place the following in order of priority . . . How would you decide about . . . ? What criteria would you use to assess . . . ?)

The other meta-data associated with questions is format of questions; some of the example type but not limited to be: Descriptive (Enter textual comment (free form writing), Drive answer based on certain step, Comprehension); Non-Descriptive (Fill in the blank, Single select from multiple choice (Select one correct answer of the following choice), Multiple select multiple choice (Select all correct answer of the following choice), True or False, Single select with no wrong answer, and Rate the question etc.)

The Meta-Data associated with the question that is aligned with the memory retention aspect. At high level, according to one theory there are three area of human memory. 1) Sensory Memory, 2) Working Memory and 3) Long Term memory. As experimented and defined by an early pioneer of experimenting with memory Hermann Ebbinghaus suggests that, without repetition or other encoding methods the MEMORY decayed at rather an exponential rate. People tend to forget about 75% of what they learn only 48 hours after without special encoding. Based on the theory to best position, or retain the information into the long term memory area of learner, the timing Meta-Data can be associated with the Question.

Some of the example Meta-Data associated with learning and practice time line but not limited to can be: Learning and practicing time—Best time of day (values—Just before sleeping, Late in the evening, Early in the morning, and so on); Practice mode to retain information of Question (values—Write 20 times, Speak 10 time loudly, and so on); and to retain this in long term memory review this Question after (values—1 Week, 2 Week, Recurring 1 week for 3 week, Re practice this question after—after x number of day, and so on).

Other type of meta-data that plays a significant role in learning process is that of the subject area and topics. By tagging the contents (Questions) to a more granular sub topic level and analyzing Learner/Student response against those will provide a more detailed insight into the learning strength and deficiencies of the learner (student). As an example for a math, Geometry Question Meta-Data associated with Question but not limiting to, is: Subject (value—Math), Sub Topic (Value—Geometry), Sub-Sub Topic (value—Three dimensional objects) etc. The embodiment of this meta-data can be in a flat structure or it can be in a hierarchy format.

Several other important metadata tied with questions are shown below for example only, but are not limited to: Default school grade level (values—8^{th} grade, 9^{th} grade etc.); Difficulty level (values—medium, low etc.); Average time student should take to answer this question (value—45 seconds for 8^{th} grade, 30 seconds for 9^{th} grade); Appeared in exam—This list can be populated for global standardize Test or the local exam. (values—1999 final exam, 2000 final exam, 2001 final exam, 1999—SAT exam, 2003—SAT exam, and so on.); Dependency level—a coding mechanism that shows the relative sequence between the questions.

Question framing (values—Trick question, Straight forward question, and so on.); and Best resources to get more information—this list car be a book name, a tutor contact, a link on internet or any other thing. The example values are: (values—Books, Papers, Links, and so on.)

Another category of Meta-Data is Cognitive Meta-Data (CMD). This is the data that is associated with the “thoughts” in Learner (Student) mind as they process each Question during learning and practice session. Some of the CMD can also be derived from combination of QMD, QRD and other CMD elements. These thoughts provide very valuable and are reflective of student learning knowledge status, intelligence level, intelligence types and their understanding of the topic. Some of the example categories and corresponding value for the question: “If a circle has the diameter of 8, what is the circumference?” can be but not limited to are: Personal difficulty level for question (value—Hard), Personal confidence level for question (value—Medium), Personal strategy applied to solve this question (value—Calculation), Personal interpretation for question make up (value—Straight forward), Personal follow up review for this question (value never), and so on.

These thoughts are unique to each student and they change with time. For example ‘Personal difficulty level’ may be high in the initial practice session, but it may become medium or low as student develops concepts. The more detailed explanation and values of various CMD is given below, but it is not limited to the list of: Personal difficulty Level (values—Very high, High, Medium, Low, etc.); Personal understanding status (values—I got it, Need to practice few more time, Need to review the theory and topics, Need help to understand fundamentals, etc.); Personal probabilities take—Student's probability for this question appearing in the Exam (values—Very high, High, Medium, Low, etc.); Personal confidence level in solving these types of Questions (values—Very high, High, Medium, Low etc.); Personal strategy applied for solving the question (values—Elimination, Guess, Calculation, etc.); Personal assessment on Question make-up (values—Excessive information, Confusing question, Indirect question, Trick question, Direct question, etc.); Personal follow up status for this Question (values—Need to memorize this, Need to practice these type of question, Solve it again, etc.); Personal review time in future (values—Never, Before final exam, Before mid term exam, <Date value>, etc.); and Personal knowledge retention trick (values—Use mnemonics, Write 20 times, Speak loudly).

Another category of CMD is derived from other data. For example, by analyzing various Question responses by a Learner/Student over period of time, it can be deduced that the Learner needs significant help in one particular subject and they are naturally good in some other subjects.

Perception about time taken to answer the question (values—Below expected time, At expected time, Over expected time, etc.)

Personal subtopic—Student view of the sub topic (zero or more) as they group the information.

Another category of data that is collected and analyzed is Question Response Data (QRD). This is traditionally what the user will respond for each Question as they process or answer them. Certain computer based learning tools may allow for additional data to be captured. So for our example the QRD for the example question; If a circle has the diameter of 8, what is the circumference is: Answer (value—C), Comment (User enter free form text) Mark for Review (values—no).

As QMD and TMD Meta-Data are utilized in MMBL methodology for analysis it needs to be attached with Tests and Question for MMBL to be accurate. There are various mechanisms to tag/attach the Questions and Tests with out being intrusive or burden on to the learner, student. A few of the example methods are described below but it is not limited to these methods only.

In one of the embodiment described in the “Diagram Description” section the tagging can be done by the creator/Author of the question at the time of creation of a Question and Test. The creator can do the tagging for QMD and TMD.

An instructor can select a set of Questions from a pool of Question to be used by his/her students and tag only the questions that are part of the Test with QMD and TMD. This will help students remove certain amount of friction and will give better insight when analyzed by the MMBL analysis engine. The instructor can tag TMD, QMD, and expected baseline CMD. The student will populate individual CMD and QRD.

In one scenario, the learner/Student tags the Questions before the start of the learning or practice session. At completion of the session, the analytics engine will be able to provide more detailed and granular information about where the student needs to focus and what the issues area are. In another scenario the earner/Student can do a complete or partial tagging as they respond to each Question in the Test. At the end of the session the student will have the analysis of the Question at more detailed granularity and dimensions, especially for the ones they tagged.

In another scenario, the Learner/Student can do a tagging only for the questions they answers incorrectly or skipped after they have completed the iteration of the test. This may be the most optimal way for them to analyze their weakness and strength. The student can apply the combination of any of the methods listed above.

Another way of tagging the content is by the use of collaborative mechanism by number of people. When a user (creator, instructor, student or any other entity) tags the information for small set of questions, this subset of information is aggregate and a more comprehensive Meta-Data set is generated. In one of the embodiments of this can be via the use of internet, the web server and the application server based solution set as described in the ‘Detailed Description’ and ‘Diagram Description’ section of this document.

As will be described in greater detail below, the system can work in various modes. In one of the embodiment the content provider (the people who are expert in the art of creating Tests and Question for student assessments) can create the Question in the tool of their choice, and they can associate the QMD with each question as they are creating the Question. These questions along with QMD can be loaded into the system. The external content provider data is transformed and is persisted in the data Store. The content and the tagged Meta-Data will be persisted in a data store. Any party by leveraging web client can create the content and tagging. They can also tag the previously created or existing contents. They can also retag the existing information. A user with system installed with the software can also work in the offline mode. In the offline mode the user can download subset of Tests/Questions to their personal machine via number of means from where they can practice, learn and tag the Questions and Tests. This information will be synced back to the server on the user initiative as described in later part of document.

In MMBL methodology the combination of Question Response Data (QRD), Question Meta-data (QMD), Cognitive Meta-data (CMD) and Test Meta-Data (TMD), along with the time spent on each Question by learner/student during learning and practice session is utilized for various purposes. This include to analyze the student learning patterns, intelligence level, intelligence types, summarize the focus area from different point of views and generate recommendations that are personalized to the learner needs and goals. The derived analysis also help in eliminating the friction for learner/students and other users for finding, extracting Questions based on various Meta-Data values. This provide an opportunity to the learner/student to focus on the area of their choice or need and spend more time on real learning instead of preparing to learn. Some of the benefits of MMBL and analysis and recommendation algorithms are described below as examples but are not limited to this listing.

During the learning process one of the key advantage of MMBL methodology is to remove the friction from the learning process for Learner/Student and Teachers. This is achieved by analyzing the user response from multiple dimensions by leveraging QMD and CMD to help student focus on their key issues area. For example, knowing the final correct score is single dimension information. But, when the student accuracy score is mapped against the time taken by each question the added dimension provides a very different insight which is very valuable to create targeted learning. The MMBL allows for analysis by leveraging multiple dimensions from QMD, CMD, QRD and time taken.

Once a Learner/Student start the learning or a practice session, the data for the QRD and CMD is captured. At the completion of the test the analysis engine starts up and performs the analysis for the QRD, time taken, against QMD & CMD and presents the information in variety of ways. Some of the example breakdown, but not limited to this list are as follows: Quantification of responses (breakdown value—Questions responded, Question responded correctly, Question responded incorrectly, Question skipped); QRD combined with CMD (values—correct, incorrect, skipped) for Questions tagged as “difficult”; QRD combined with CMD (values—correct, incorrect, skipped) for Questions tagged as “probability of high to appear in exam”; QRD combined with QMD (values—correct, incorrect, skipped) against QMD (Meta-Data elements—Subject, Subtopic, Sub-sub topic, Question type, knowledge type etc.)

This breakdown analysis can than be utilize by the learner/student, instructor, parent or other parties to help learner/student focus exactly on the issues area. The student can do more tagging of the information to get more granular and detailed understanding of their strengths and weaknesses.

As the personal response data and CMD history for the Learner/Student begun to grow in the data store, an analysis engine can process the information about the Learner/Student to identify if the particular topics is a natural strength of the Learner/Student Based on the different meta-data and the input of the student there are number of algorithm that can be applied for the analysis, one of the example algorithm is shown in FIG. 3 (Analysis matrix for a topic for a student based on accuracy and time taken to complete the Tests) and explained in the Detailed Description and Diagram Description Section.

Another example algorithm to analyze the relative topic strength and inclination for a student is shown and described herein. The analysis of all scores of a student relative to the expected time will give an indication of relative strength and weaknesses. More details about this are in set forth in the Detailed Description below.

When the response for a group of Learner/Student (related by certain profile segment like class, age, school, instructor, content used etc) is analyzed for associated instructors or for content used in the learning process, it provides a quantified view point on fundamental pillars of learning. The analysis result quantifies the discrepancies that can be attributed to different aspects of fundamental pillars. This quantification will be an indicator of which of the component potentially needs an improvements.

The benefits and algorithms referenced above are just a few examples. Various combinations of Meta-Data from QMD, CMD, TMD along with QRD and time taken by Learner/Student can be leveraged to generate algorithms and analyze Learner/Student learning patterns, intelligence level and intelligence types. The Learner/Student does riot have to spend any time comparing their responses to the right answer. The correct answers are already stored in the content store along with the Question and the system can do the automatic comparison. The Learner/Student does not have to spend time tagging any Question if they don't want to.

The learning and analysis tools enable the user to select from the plurality of analysis algorithms to understand where the focus needs to be put to make improvements. The MMBL has the ability to analyze the single student details based on QMD/CMD or with reference to a group of students. This analysis and recommendation will help leaner to significantly improve their learning efficiency. This efficiency will improve over time as the history about a learner/student grows over time. This analysis reference can eventually be rolled up to any level of grouping. Example possibilities are school, city, school district, state and national. Similarly in the enterprise setting with big training programs this can map to a learning center, a location, state, business unit, and country etc. Effectively the MMBL analysis and recommendations can improve the efficiency of all fundamental pillars in learning process (the learner/student, the content, the instructor and the delivery mechanism).

### BRIEF DESCRIPTION OF THE DRAWINGS

The foregoing and other objects and features of the present invention will become more fully apparent from the following description and claims, taken in conjunction with the accompanying drawing. Understanding that these drawings depict only typical embodiments of the inventions and are, therefore, not to be considered limiting of its scope. The invention will be described and explained with additional specificity and detail through the use of the accompanying drawing in which:

FIG. 1 illustrates a process flow of learning process that leverages Meta-Data and Metrics Based Learning (MMBL) Methodology in accordance with present invention;

FIG. 2 depicts the process flow for ‘removing the friction’ from learning process for learner/student in accordance with MMBL;

FIG. 3 illustrates an Analysis matrix and Algorithm which leverages various Meta-Data, QRD and response time—Analysis for a Learner versus peer croup based on accuracy and time to complete the Test;

FIG. 4 illustrates an Analysis matrix and Algorithm which leverages various combination of Meta-Data, QRD and response time—Analysis matrix of a Learner for multiple subjects;

FIG. 5 illustrates the logical data persistence structure for Trend Analysis—Data points over time;

FIG. 6 illustrates the logical data persistence structure for Fundamental Learning Pillar analysis algorithm based on Timing and Accuracy;

FIG. 7 depicts the flow chart for implementation of an exemplary user interface;

FIG. 8 depicts the high level Logical Architecture Component for implementing MMBL;

FIG. 9 illustrates the Detailed Logical Components of software solution;

FIG. 10 illustrates the Data synchronization architecture;

FIG. 11 illustrates the Logical Component architecture for implementation of MMBL;

FIG. 12a illustrates the Entry Page/Home Page for an implementation of online solution;

FIG. 12b illustrates the Login and Account request page for an implementation of online solution;

FIG. 13 illustrates the Quiz/Test List page for an implementation of online solution;

FIG. 14 illustrates the Quiz/Test Detail page for an implementation of an online solution;

FIG. 15a illustrates the Question List with QMD and filter page for an implementation of an online solution;

FIG. 15b illustrates the Question List with user CMD and filter page for an implementation of an online solution;

FIG. 15c illustrates the Question List with user history and filter page for an implementation of an online solution;

FIG. 16 illustrates the Take Test page with QMD and CMD section Collapsed for an implementation of an online solution;

FIG. 17 illustrates the Take Test page with CMD section Expanded for an implementation of an online solution;

FIG. 18a illustrates the Test Result Summary page for an implementation of an online solution;

FIG. 18b illustrates the Test Result Analysis by QMD and CMD dimensions for an implementation of an online solution;

FIG. 19a illustrates the Result analysis page for an implementation of an online solution;

FIG. 19b illustrates the Learning Summary Dashboard page for an implementation of an online solution;

FIG. 20 illustrates the database model for User Information module of a software solution;

FIG. 21 illustrates the database model for Contents: Test, Questions and Answers module of a software solution;

FIG. 22 illustrates the database model for User Responses+Cognitive Meta Data module of software solution; and

FIG. 23 illustrates the database module for Organizations and Training Setup module of a software solution;

### DETAILED DESCRIPTION OF THE PREFERRED EMBODIMENTS

It will be readily understood that the components of the present invention, as generally described and illustrated in the figures herein, could be arranged and designed in a wide variety of different configurations. Thus, the following more detailed description of the embodiments of the system and method of the present invention, as represented in the FIGURES is not intended to limit the scope of the invention, as claimed, but is merely representative of one or more methods of implementing the invention.

The present invention operates on a personal computer or on a server. The personal computer may or may not be attached to a network enterprise. In one specific embodiment, the personal computer connects to a network enterprise, which includes at least one network server that maintains the learning program so that it may be accessed by one or more students. The network server may be coupled to a plurality of client computers, such as personal computers or workstations, and may alternatively be coupled to the internet or through the World Wide Web. The server also maintains programs and information to be shared amongst the users of the network. The client computers are coupled to the server using standard communications protocols typically used by those skilled in the art to connect one computer with another so that they may communicate freely in sharing information, programs, and printing capabilities.

The computers used within the enterprise or by a sole learner are also well-known in the art and typically include a display device, typically a monitor, a central processing unit, short term memory, long term memory store, input devices such as a keyboard or pointing device, as well as other features such as audio input and output, but not limited thereto. Using conventional programming techniques, a software program is loaded typically on the server in the long term store that is then accessed by a computer being utilized by a student so that the program is then loaded onto the student's system using a combination of the short term memory and long term memory store for efficient access to data and other elements within the program often accessed during student interaction. Other calls may be made from the program to the server to retrieve additional subject matter or information as necessary during the student's, instructor or administrator interaction with the program.

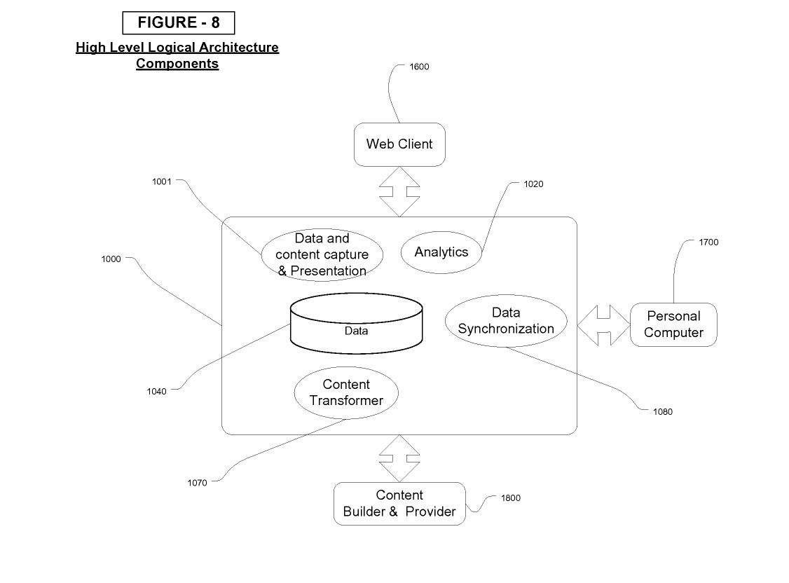

A thin-client implementation of the learner interface of the present invention is implemented using standard web-browser technology, such as web browser (1600 and 1000 in FIG. 8), where the bulk of the processing is performed on the network server or web server on which the program is stored and maintained. The primary responsibilities of the browser client are to display the generated content to the learner, offer navigational options, provide access to administrative facilities, and serve as the user interface. To aid the learner when difficulties arise that the system is unable to resolve the user interface also provides convenient access to tools for synchronous and asynchronous communication with other.

Synchronous communication channels include voice and video conferencing, net meeting, chat, and collaborative whiteboard technologies. Asynchronous communications include newsgroups, email, and voice-mail. The system also maintains a database of Frequently Asked Questions (FAQ) for each class and for the system as a whole to augment the information contained in the online help.

What is significant about the learning, assessment program stored on the network enterprise or on the student's own personal computer is that the learning and assessment program has the ability to capture the student's input on the subject matter including CMD, analyze the result and provide the opportunity to the user to analyze their understanding, their individual trends and the trends against the defined groups of learner's/students in general.

Thus as the Learner/Student submits response to questions, two types of information is captured. 1) Answers to the questions, and 2) Cognitive Meta-data (CMD) values, associated with the questions. This Meta-data along with the responses is analyzed against the reference model or against the pre-defined group of learners or against the public group to create the relative strength and weakness of the students at various level of granularity. This data is also utilized to perform the fundaments pillar of learning analysis.

Additionally the user has the ability to analyze and visualize the given Test from many analysis angles (example scenario: create a new test for all the question that were answered ‘incorrectly’, has a difficulty level of ‘medium or low’ and has the probability of appearing in exam ‘high’). This sub setting and filtering provides the Learner/Student an opportunity to learn and practice at the pace they want, and feel most comfortable.

Thus a MMBL based system becomes a truly personalized learning and practicing device and methodology for the student, it can create the learning session truly customized for individual student. Additionally if the user wishes, the data can be synchronized to do the fundamental pillar analysis that will provide the insight to them where and how much effort they should be putting into their learning. This enables the Learner/Student to learn faster, as they have deeper and quantifiable understanding of their issues and focus areas, as well understanding of their peer groups or public in general. They are not forcing themselves on topics for which they do not have the right support from other pillars. They comprehend the information more fully, and retain the material longer than would otherwise be possible in a standard learning mode. This also enables the group instructor and leader to get deeper understanding about their learner/student, student groups and about themselves and their contents.

There are number of additional features within the program that enables the system to provide a user the option of reviewing materials previously completed. The Learner/Student can review and replay any of the previously completed sessions, the results associated with each session, the data captured during each session. They can compare the two different sessions for the same Tests by same user or with other Students.

As the Teacher/Instructor and the Learner/Student uses the system in a group setting, the history of the fundamental learning pillars builds up. The system develops the understanding of natural strength of Student, the relative impact and strength of fundamental pillars and removes the friction from the overall learning processes. Based on the history and the relative strength and weaknesses analysis engine can also provide the learning recommendations. Additionally the user will have the option to tune the system to its learning liking and pace. The preferences will be saved to be utilized for later analysis as well as future learning sessions.

The trends analysis model is a way of point out to the student/their instructor/parent the relative strength and weakness for a subject in a quantifiable way, it is up to the user to apply the external and subjective explanation and utilize the data the way they seem appropriate. The fundamental pillar analysis is another quantifiable way to suggest the discrepancies between the different groups of student, this data will also needs to be qualified with subjective explanations and utilized the way it seems appropriate.

### EXAMPLE AND USER INTERFACE DESCRIPTION

All of the screens referenced and described in this section illustrate one embodiment from among a number of possible variations of the invention described and claimed herein. They are shown here only to demonstrate the concept and in no way confine the functionality to what is shown or how it is shown on the screens. In a similar way the data example shows is just to explain the concept.

In one example, a user selects and practices for a standardize exam test, which has only non-descriptive questions (example: select one of the following, fill in the blank, true/false, select all of the following answers, etc). The user is practicing for math section. The test has total of 100 questions.

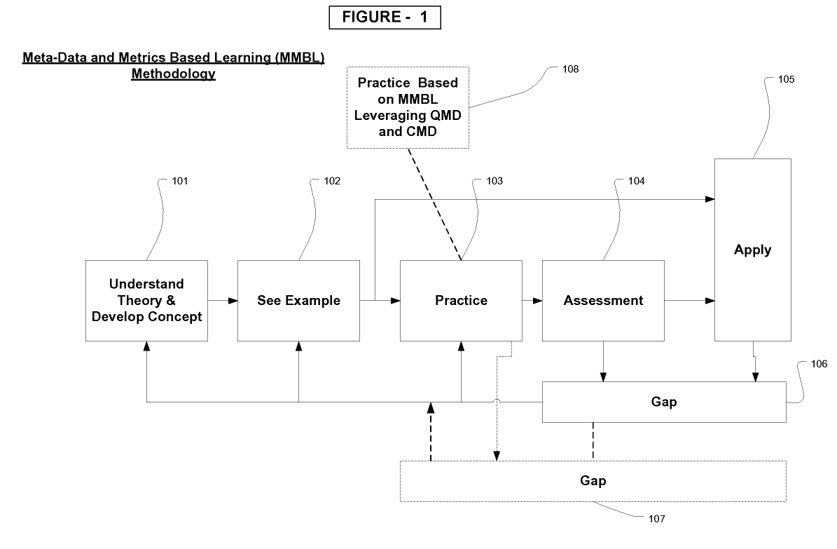

The user using the MMBL methodology, as depicted in FIG. 1, goes through each question and entered CMD and QMD for few of the question. At the completion of test (entering the response for 100 questions), automatic result comparison is done. The system analysis concludes that user answered 75 questions correctly, 15 questions incorrectly and skipped 10. Leveraging MMBL methodology of the invention, the user is presented the analysis in number of possible granularity details that provides user deep insight into his/her understanding of the topic. Not only user gains the understanding of their knowledge, their strength and weakness, the user is allowed to practice for any aspect of Tests question based on the available MMBL metrics. The scenario show is for one Test/Quiz that contains 100 questions. But, the principle is applicable across number of quizzes and can analyze questions in number of selected quizzes and also across number of practice session. Similarly the data can be incorporated and analyzed at class and group level and provide an insight into students learning pattern, currently not easily possible by conventional means.

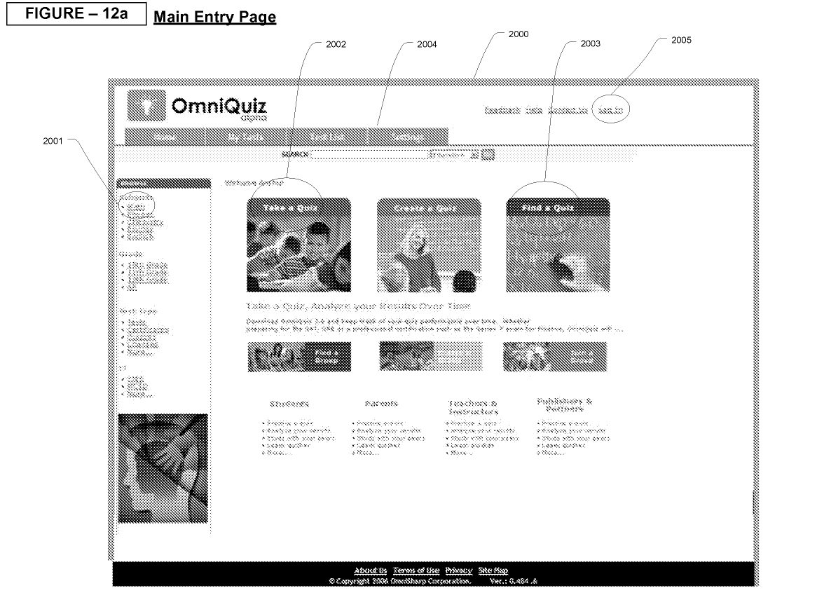

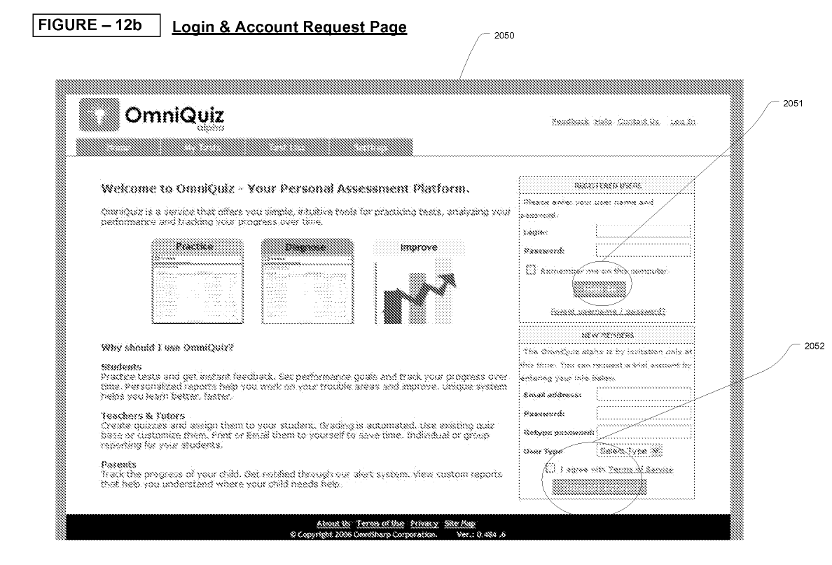

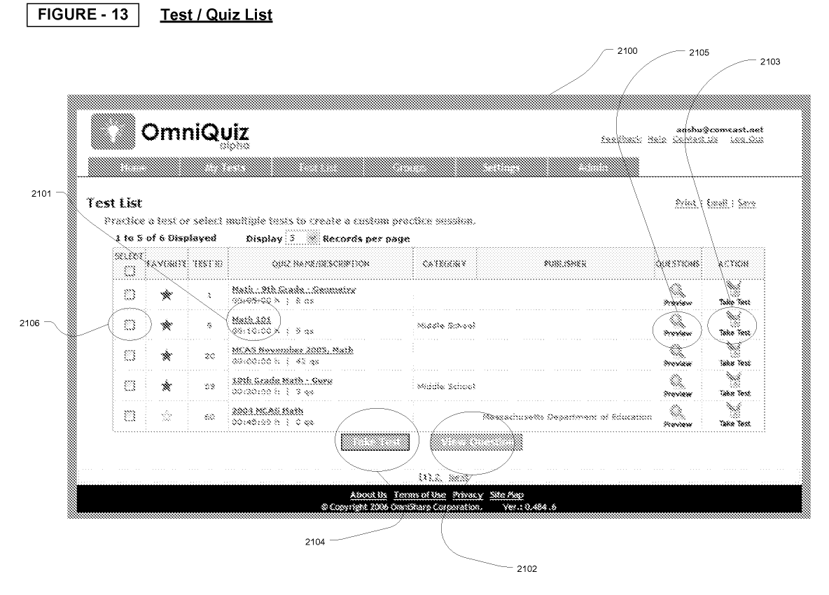

As shown in FIG. 12, for a web based user interface implementation the User (Learner/Student/Teacher/Instructor etc.) starts the interaction with the system on the entry page (home page). From here the User is able to initiate number of possible actions (few of them are shown here). These actions are triggered by using the publicly known and in use techniques. One of the actions for the user is to either ‘Find a Quiz/Test’ (2003) or to ‘Take a Quiz/Test’ (2002) or User can click directly on the popular Quiz/Test by category (2001). In this scenario User click on 2001. At this stage the user is presented with the FIG. 13 (2100). This is the List of Quizzes/Tests along with relevant information.

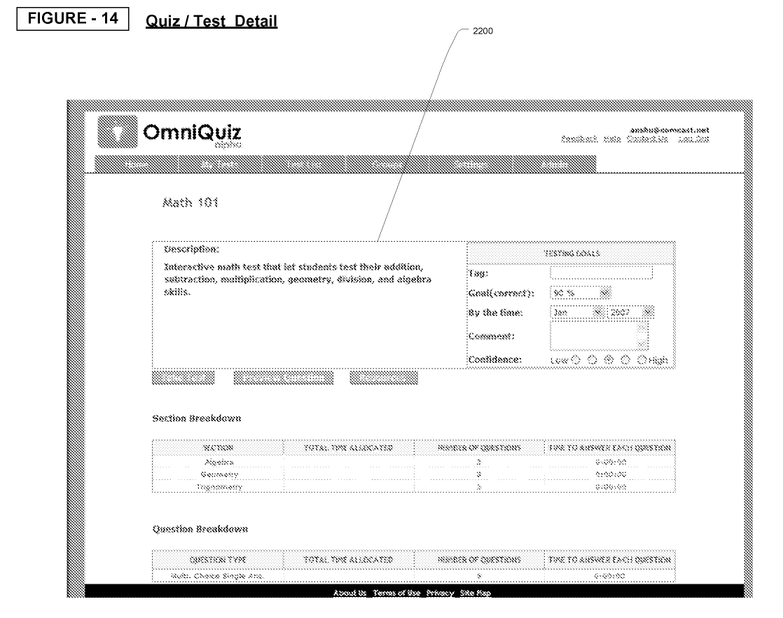

As shown in FIG. 13, a User clicks can initiate number of action. One of the action user does is click on the Quiz Name (2101). The user is presented with the FIG. 14. On this page the user is presented with details of the quiz which has information about the make up of the question, as well the summary of analysis for other users.

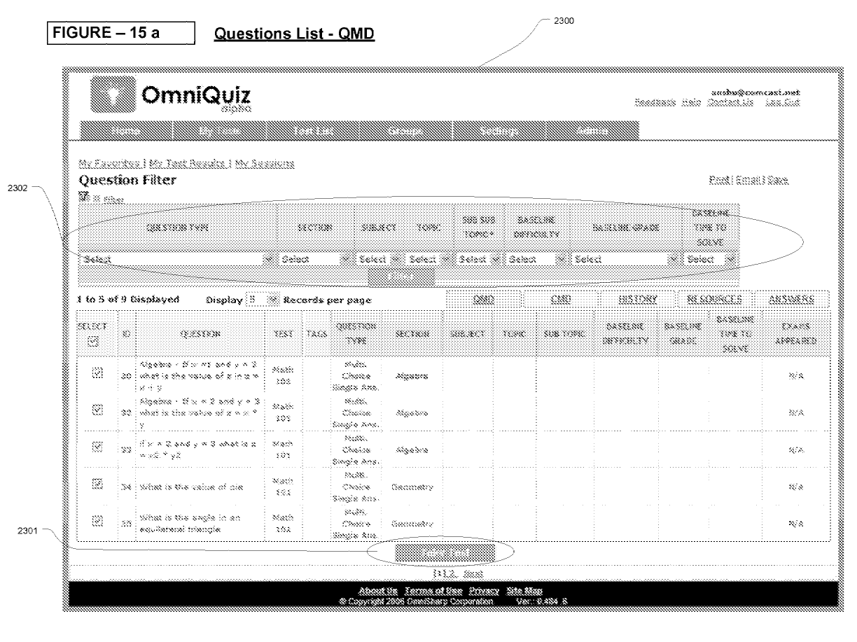

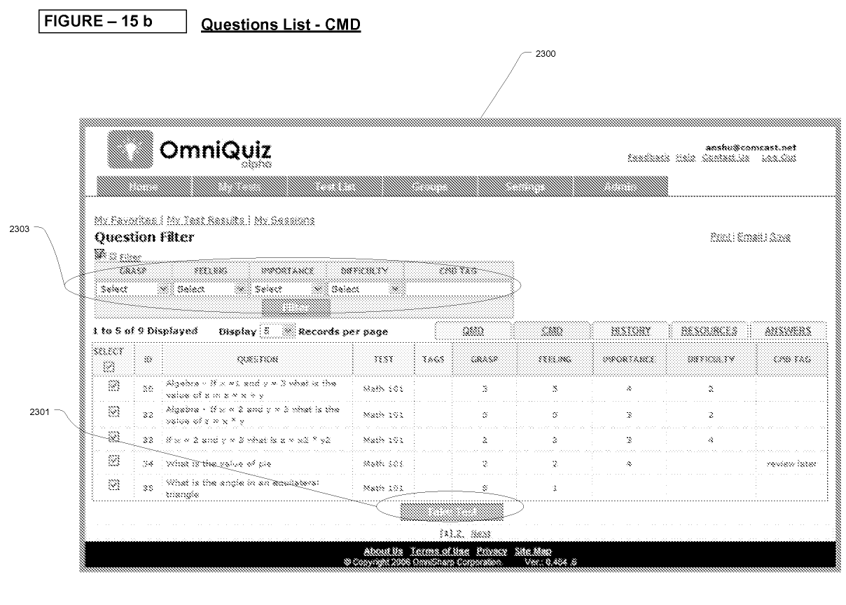

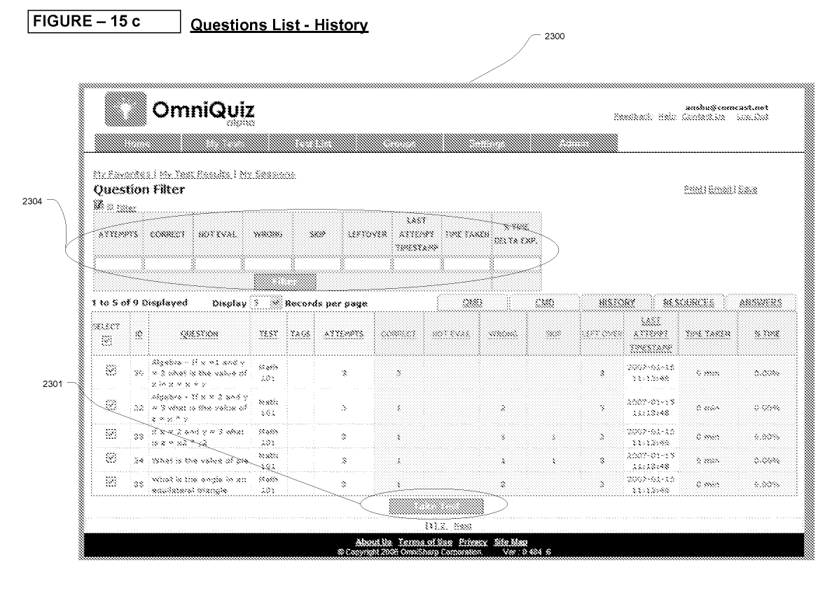

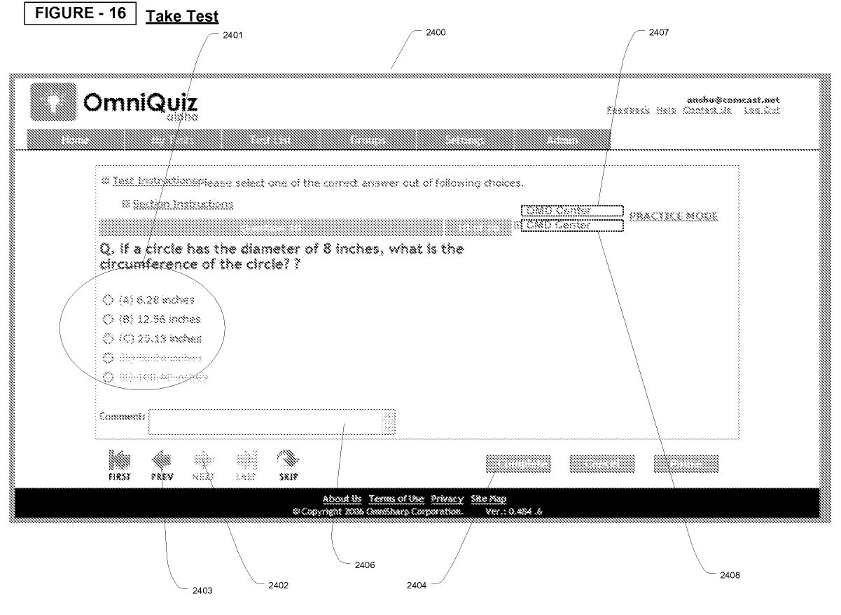

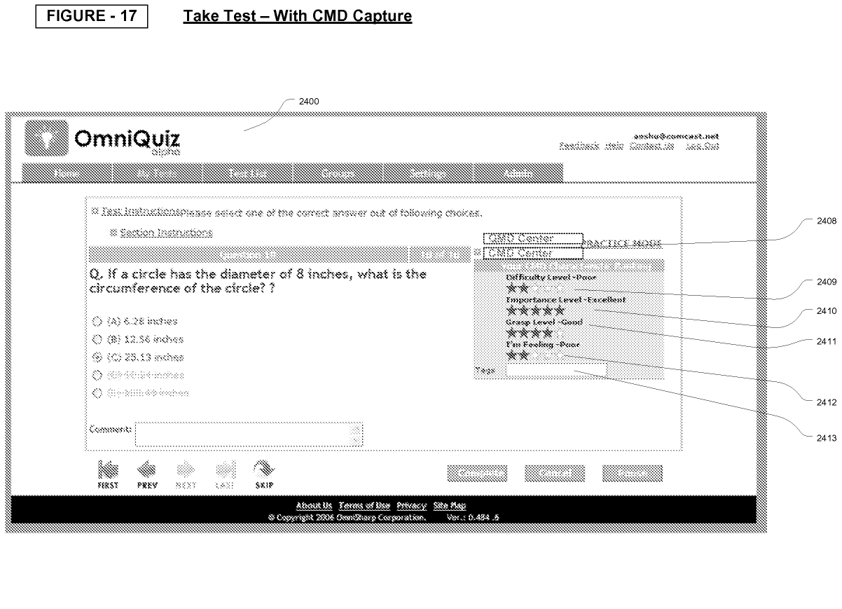

A User can clicks on ‘View Question’ (2102), the User is presented with FIG. 15 (FIG. 15a, 15b, 15c). This is the list of questions. According to scenario user clicks on FIG. 13 on ‘Take Quiz’ (2103). This action presents the FIG. 16 (2400) to the user. On this Figure the User can take number of action, which in the simplest form is an input screen for marking the answer for each question. As User marks the answers for each question, than clicks on next (2402) and so on for all 100 question the responses (QRD) and other data is captured in the data store. Optionally, User does click on CMD Center (2408) as shown in FIG. 16 and FIG. 17. The user can enter number of his/her mind thoughts on this screen. The list of ‘thoughts’ in CMD center is a configurable list which can be configured for each User. In current scenario User enter Difficulty (2409), Importance level—Probability of this to appear in exam (2410), (Grasp—Understanding of concept for this topic (2411) and I'm Feeling (confidence about this topic) (2412) and so on. Optionally, User can also enter comma separated tags in the free form text field (2413).

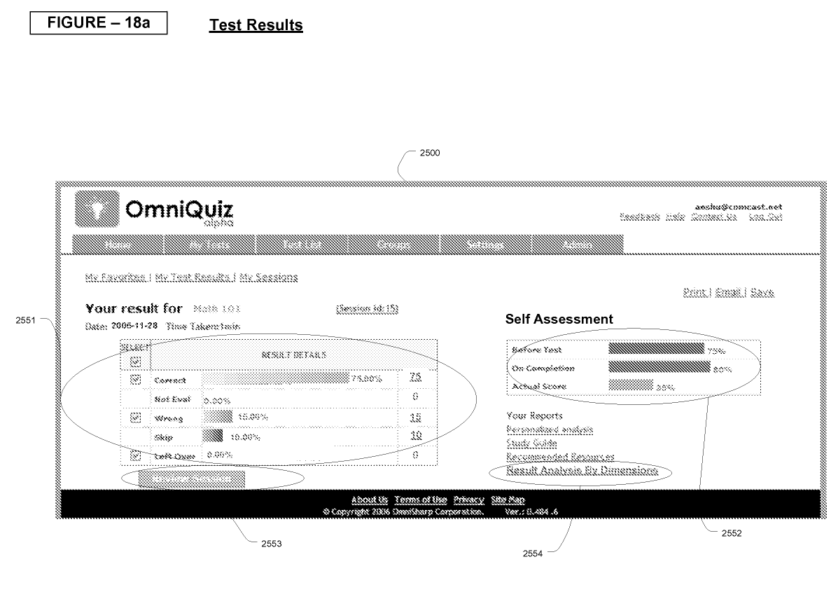

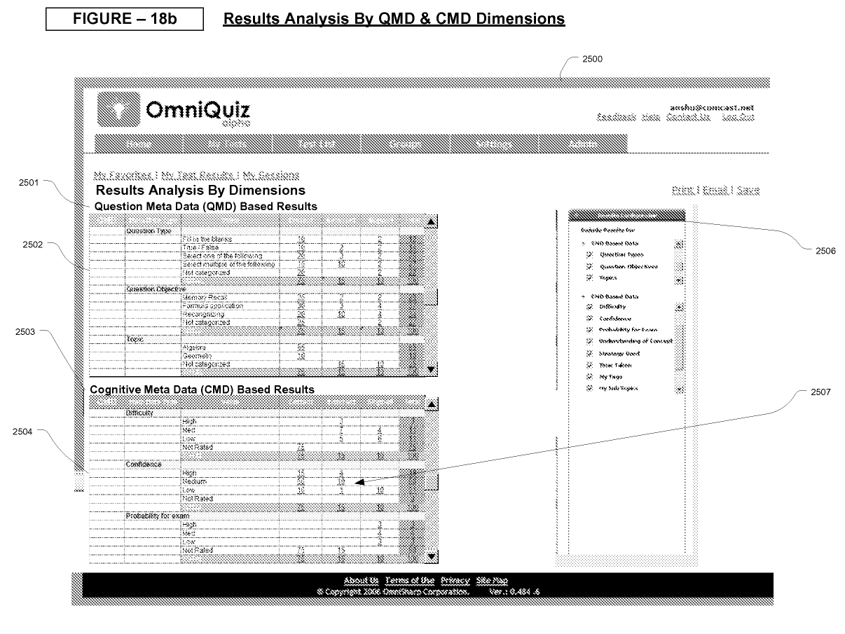

When a User answers all 100 questions and clicks on Complete (2404) the user is presented with FIG. 18a (2500). On this screen the quick snapshot of Test Session Results are shown. It shows the breakdown by various response statuses (2551). User can select any combination of status set and review the session for those by selecting items in 2551 and clicking on 2553. 2552 shows the another report about assessment; the expectation of score by User before Test session, The expectation of score after completing the Test session but before the system calculated the result and the actual result. There are additional reports accessible to User, clicking on 2554 opens the FIG. 18b. The Test Results screen, on this screen, the user response is analyzed and is presented in a variety of Meta-data metric. For example all the QMD and CMD that was available for questions in Test are used in creating a metric based analysis. As shown in example, user correctly answered 75 questions, incorrectly answered 15 and skipped 10. Using QMD the user is informed (2502) that he/she incorrectly answered 10 questions that were of type ‘Select Multiple of the Following’. Using CMD (2503) and CMD based analysis (2504) the user is informed that there were 5 question that user considered as Low Difficulty where answered incorrectly and 6 question that user thought were of Low Difficulty were skipped.

The user can click on any number in 2502 and 2503 and a new test session will be created consisting of the selected choice. For example if user clicks on 2507 (the question with Medium Confidence that were answered incorrectly). This will result in a new test session of only 10 questions which meets the criteria. Hence the user can practice from any dimension of metric to achieve the desired knowledge objectives.

As shown in FIG. 18b, the user can also control the QMD and CMD results that are shown on the page by selecting the options in 2506.

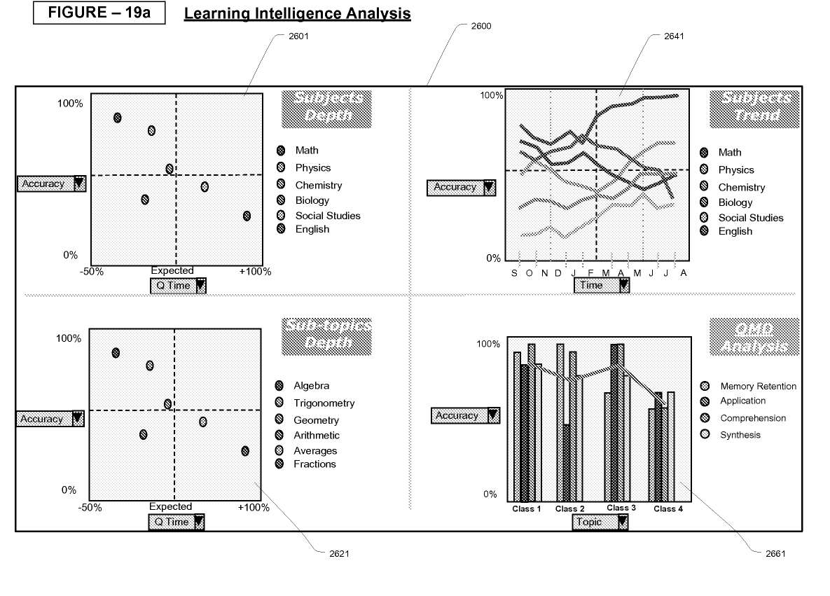

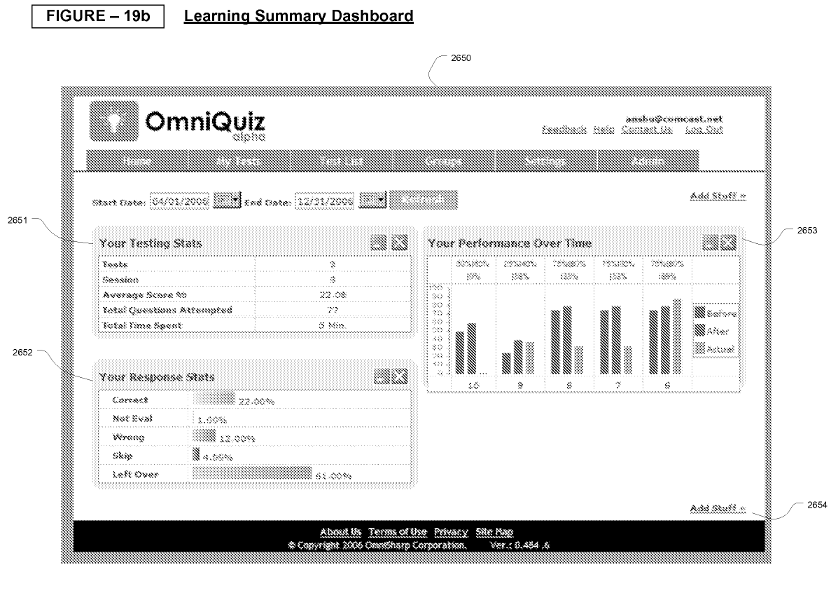

The user also has the ability to see their overall performance. As shown in FIG. 19a, number of analysis can be conducted based on the data collected while the student was practicing and learning using MMBL methodology. There are number of possible variation based on member of combination of QMD and CMD which can be utilized.

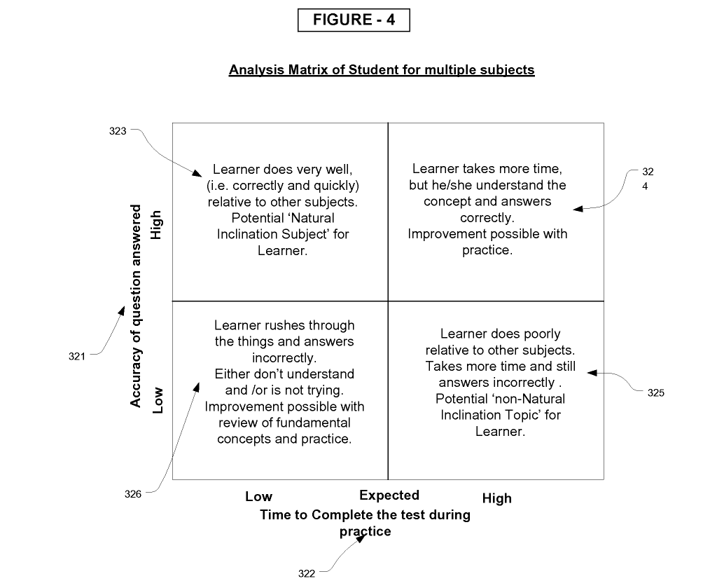

Some of the sample analysis is explained here. 2601 is the analysis of the students understanding across different subjects that are practiced using MMBL. According to this analysis the time taken by student for each question of each subject test session and the accuracy of the question answered is analyzed and the student knowledge is visualized as explained in FIG. 4.

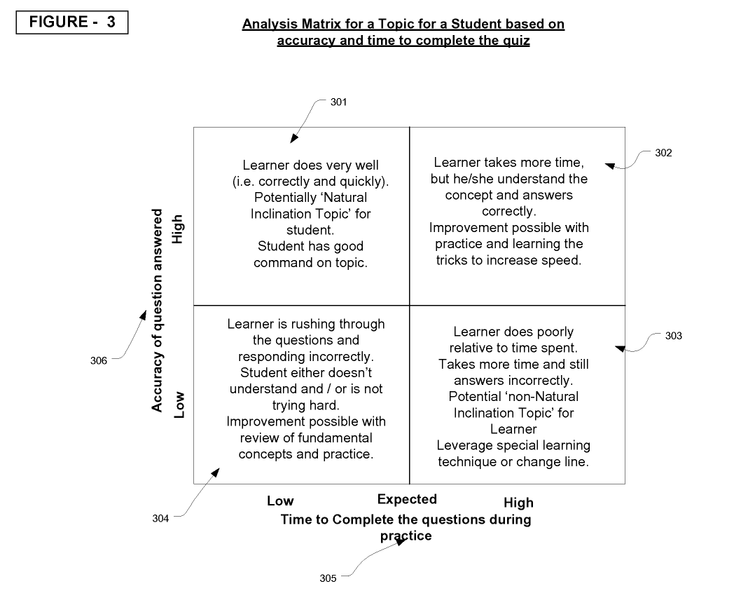

Similarly the students test sub-topic details is analyzed and shown in 2621 which is the implementation of algorithm presented in FIG. 3.

2641 demonstrates the knowledge trends for different subjects that are practices using MMBL. 2661 demonstrates the analysis based on the QMD data. The user can get a summary snapshot of their learning and practice effort as shown in FIG. 19b (1650).

### Diagram Descriptions

A general learning process is shown in FIG. 1. This also correlates the way learning and training contents are designed. For example, a typical text book will have chapter, the chapter will have theory and concept, with scattered example and the questions at the end of the section/chapter for assessment purpose. As represented by box 101, a teacher, instructor, a video or a hands-on lab or real life situation will develop the concept to the learner/student. Following this the student will get to see or work with some examples to apply concepts (it may be the practice example or the lab or real life example). These examples demonstrate how the concept or theory is applied—box 102.

In certain setting (especially in enterprise and corporate training) the student directly goes and applies (box 105) the knowledge they have gained. But in many situations, the Learner/Student have to do the practice (box 103) for various aspect of theory, example: to remember the concept, facts and contents etc. This situation is typical in educational/school grade, certification or licenses exam and other situations.

Following this, the User is being assessed for the amount of knowledge they have retained and can apply. The various assessment (box 104) methods and formats, but not limited to can be; verbal questioning, descriptive and comprehensive test, open book test, non descriptive tests etc. The assessment can be in time controlled environment and there can be penalty for wrong answers or combination of many other variations.

Following this assessment the gap analysis report can be generated (box 106). Many times the student is ready to apply (box 105) the earned knowledge after the concept development and example demonstration (102) or after they have practiced little bit. In this process the gap analysis (106), for the student knowledge is done either during the assessment (104) or during the apply (105) aspect.

The key issue with traditional learning approach is that the ‘Practice’ which is very important part of the learning and retaining knowledge is typically discretionary and there is no quantification and measure of how much time an individual has spent learning or practicing and where. The Learner/Student is typically practicing for two goals, that is, practice for Accuracy and practice for Timing. Another drawback is the gap analysis is typically at the end of the day, week, semester or the year. By the time student/learner comes to know they have gap, they have missed the valuable time and the tremendous opportunity to correct them.

The MMBL (Meta-Data and Metrics Based Learning) Methodology solves these issues Using MMBL the student can practice (108) in various modes of learning, these modes can be defined by the learner themselves or can be provided to them based on the past history analysis Example modes can be but not limited to are accuracy, timing, questions and topics the learner seems difficult and various combination of QMD and CMD data.

Additionally as the learner is practicing the information is captured and analyzed that provides the added advantage of quantifying the effort by the learner. The gap analysis happens in the real time as the student is practicing. So the student has the opportunity to leverage the valuable time for corrective measures.

One of the areas where a student spent a good amount of time is analyzing where they should focus and spend time. Once analysis is completed they also spent time to collect and compile material that is especially geared to them. This is especially important when preparing for some type of standardize assessment tests. MMBL provides a significant improvement on current practicing, assessment and overall learning methods and tools. It utilizes the meta-data (QMD, CMD) tagging, coupled with user response and time spent on each question to create a metric based environment where at all given time User knows the issues and can practice based on the particular issue type and goals. The amount of analysis is proportional to the amount of tagging that is available. Even if no CMD is available the student is still going to save significant amount of time by just tagging the responses for incorrect and skipped question or by leveraging QMD.

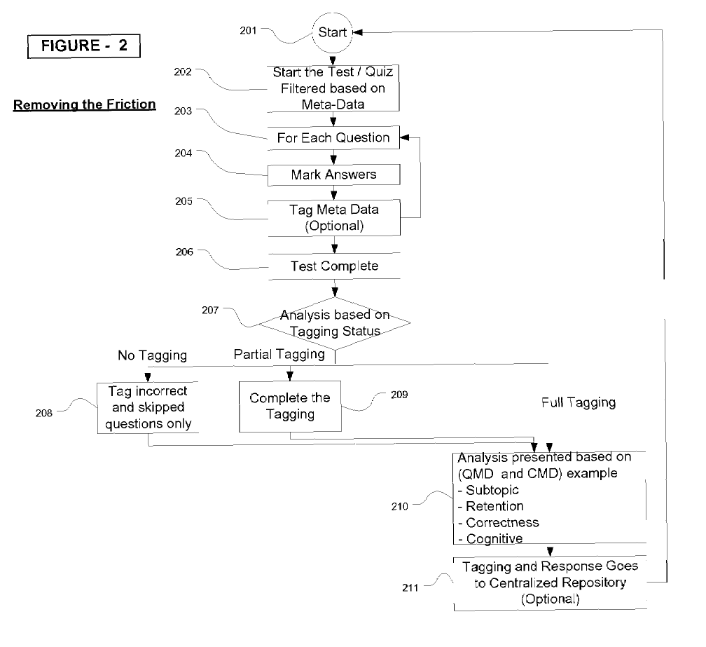

There are number of variations that are possible for this methodology, one of the possible flow is shown in FIG. 2. A student decides to practice for a topic (201). The student than select the particular Quiz/Test (202), at this stage the user will go through each question, especially the non-descriptive type, the one that includes but are not limited to; true/false, yes/no, select one of the following, select all of the following, fill in the blank, find next number in series, find and circle synonyms, find and circle antonyms etc. The User will mark the answer or enter the answer (204). At this stage the User has an option to enter some optional CMD (205) associated with that question as described in earlier section.

After the test is complete (206) depending on the status and amount of tagging either initially available (207) from earlier sessions or from the original test an analysis will be presented to the student. At the simplest level the student will have the information with breakdown of correct, incorrect and skipped. At this stage the student will have a simple list of incorrect, skipped and left over questions and user may decide to mark only those questions with CMD (208). (The skipped questions are the ones that the User consciously decided not to respond to. This may happen because either the question was too hard, or the User felt it will take lot of time and they will revisit it. The “left over” questions are those questions which were part of the session plan, but the User never saw them. This happens because either User ran out of time or patience). In case if the tagging was partially completed, User can complete the meta-data tagging for remaining questions (209). Finally if all the meta-data tagging is available, the User will have the different level of breakdown of their result (210). At this stage the User has the option to start a new test or create a new session by sub setting current Test. One of the examples filters criteria, but not limited to is: retake a Test where all the questions for student were answered incorrectly and are of type true or false. In general the new test can be a filtered subset of questions of the original test, the filter criteria is based on various QMD, CMD and QRD value combination. Optionally, the meta-data and the responses of a student can be added to the centralized repository (211). So that it can be shared and used by other students.

In actual implementation of this flow chart, the member of steps can be reconfigured to occur in various combinations and sequence and are not limited to the exact sequence shown in the diagram. This diagram is just one example to demonstrate the methodology.

In order to analyze relative strength and weakness of a Learner/Student over a period of time, the structured analysis is needed. As the usage of the system continues by a student the history of the user will begin to develop. There are a number of possible variations under the MMBL methodology and any combination of meta-data can be utilized to gain insight and quantify user learning and understanding. The example demonstrated here is one of the many possible variations for which two meta-data elements are selected. This analytics can be applied for an individual student or to a group of students related via some common means of profile (example common instructor, class, content used, school, state, school district etc.).

There are number of analytic algorithm that can be created based on various combinations. This will include answer to the questions with reference to QMD and CMD. Some of the example analytic for demonstration purpose is shown in following section, but is not limited to this only.

As shown in FIG. 3 the algorithm utilizes multi dimension data point to analyze student understanding and grasp on a subject sub topics. For example, the dimension 1 (306) shown on y-axis is the accuracy, where the low value can be 0% and high value can be 100%. The second dimension on x-axis is the time spent (305) on each question during practice session. The low and the high values for 305 are the percentage difference with reference to expected time for each question (meta-data available as part of QMD or it can also be derived by averaging time spent by number of students in a peer group for corresponding question). The 3^{rd} dimension is the type of questions, or subtopic that is included in creating the segmentation.

After practice sessions when the time and accuracy percentage for various question groups is analyzed, all responses can be segmented in four categories as shown in FIG. 3. Group 301 signifies the strength for the student. He/She responds quickly and correctly. Student potentially has a good command on this question set or sub topic. Group 303 signifies that student does not understand the topic or is not focused and hence took more time but lot of incorrect responses. Group 302 signifies that student understands the topic/subtopic but needs practice and or tricks to shorten the time need to complete the session. Finally Group 304 signifies that student took less time and come out with incorrect responses. The Student is rushing through and they are wrong. Either they need to develop the concept or needs to be focused. The dimension 306 can be changed to skipped question, incorrect answers etc. The overall analytics can be filtered based on various types of meta-data in QMD or CMD.

An algorithm in FIG. 4 leverages the similar principle as that of FIG. 3. In this instance the analysis is done for the subject as a whole. The analysis covers the data collected for number of practice session for number of subject areas. In this particular instance to do the analysis the data is summarized and plotted on the graph.

As shown in FIG. 4 the algorithm utilizes multi dimension data point to analyze student understanding and grasp on a subjects. For example, the dimension 1 (321) on y-axis is the accuracy, where the low value can be 0% and high value can be 100%. The second dimension on the x-axis is the summation of time spent (322) on each question during practice session. The low and the high values for 322 are the percentage difference with reference to expected time for each subject test (meta-data available as part of QMD or it can also be derived by averaging time spent by number of students in a peer group for corresponding tests). The 3^{rd} dimension is the subject them selves as well type of questions, or subtopic that is included in creating the segmentation. After number of practice session when the data is analyzed, the student understanding can be segmented in four categories as shown in FIG. 4.

Group 323 signifies the strength for the student. He/She responds quickly and correctly on these subjects. Student potentially has a good command on these subjects. Either Learner/Student works very hard and enjoys this and/or they are naturally good in these subjects/topics. Group 325 signifies that student does not understand the subjects or is not focused and hence more time but lot of incorrect responses. Group 324 signifies that student understands the subjects but needs practice and or tricks to shorten the time need to complete the session. Group 326 signifies that student take less time and responds incorrectly. Student is rushing through and they are wrong. Either they need to develop the concept or needs to be focused.

The dimension 331 can be changed to skipped question, incorrect answers etc. The overall analytics can be filtered based on various types of meta-data in QMD or CMD.

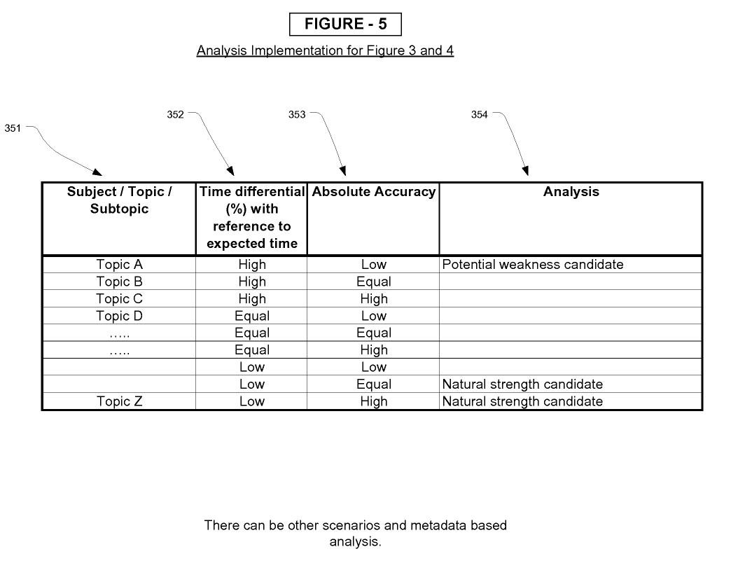

The metric driven calculation process for FIG. 3 and FIG. 4 is shown in FIG. 5. The Column 351 contains the granularity of content which can be the subject, topic or sub topic. Column 352 calculates the time differential percentage with reference to expected time. Column 353 contains the absolute accuracy. The column Analysis contains the results based on the algorithm as described in FIG. 3 and FIG. 4.

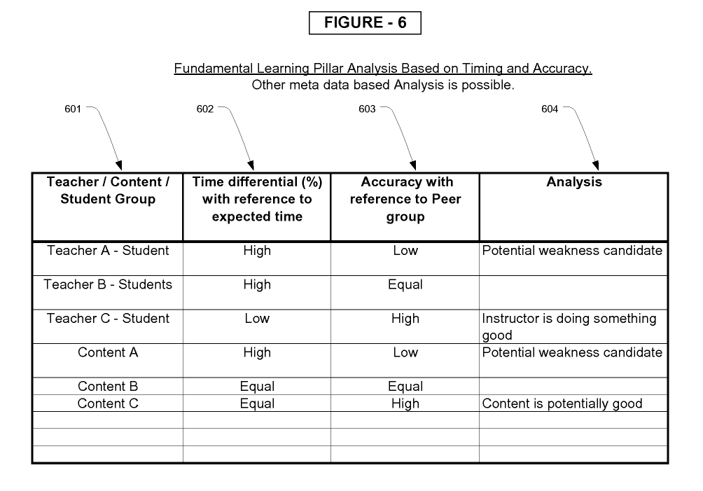

FIG. 6 shows the implementation for fundamental pillars of learning analysis. The goal of this algorithm is to quantify that out of three elements 1) student, 2) instructor and 3) content who needs most improvement for better results. Column 601 contains the component of three pillars which can be a student, teacher for a group or content used. Column 602 computes the time differential to solve the subject area questions with reference to the expected time for a group of students who are associated with the corresponding value in column 601. Column 603 contains the accuracy for the corresponding group of student for the selected subject. Column 604 is the analysis result. Potential example data is shown in the FIG. 6.

As shown in the example data on FIG. 6, sometime an Instructor or the content used for learning by student may be the cause for grade and learning intelligence fluctuation. This example analysis shown accuracy and time as two variables for analysis, but other combination of user response QMD and CMD can also be leveraged.

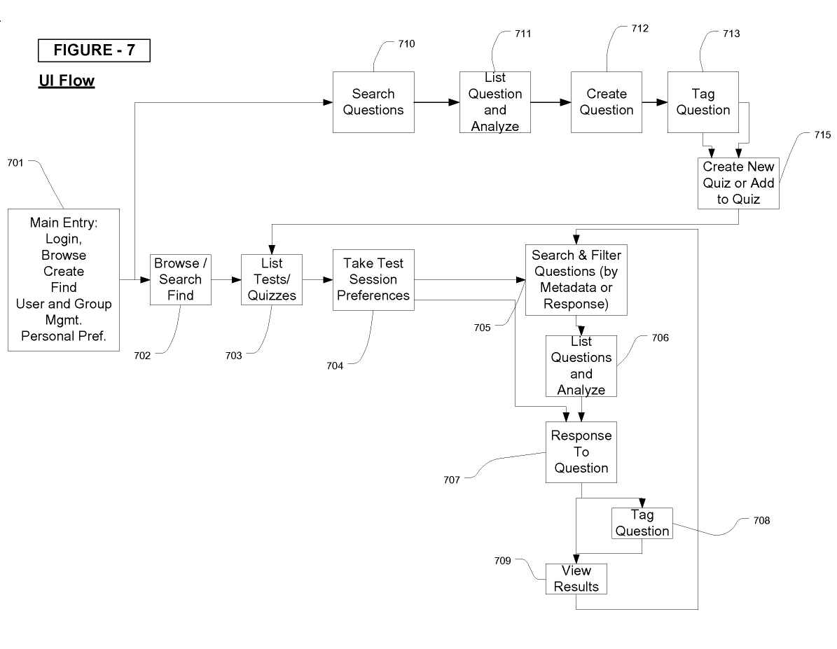

There are number of possible variations to build the user interface. One of the embodiments is shown in FIG. 7 for example purpose only. A user starts the interaction with the main page (701). At this page the user has the option to login and be recognized by the system. If they are not registered user they can also complete the registration. At the end of the registration the user will have profile setup in the system.

At this stage one of the paths a user can take is to browse or search for the Quiz/Test (702). The result of the search will be a list of Quizzes (703) with certain Meta-data and other information. The user can optionally look at more detailed information about the Quiz/Test. After selecting the Quiz/Test a user may decide to start the practice and learning session. At this time the user will have the choice to set up the learning session preferences (704). Certain example parameter a user can set will include practice for accuracy, or timing, or difficult question etc.

The user can start the process of responding to questions directly (707) and also optionally tag each question (708). After user completes the last question or marks the quiz as completed the analysis is presented to the user (709). In addition to simple correct, incorrect and skipped questions a user gets to see the analysis by other meta-data element dimensions. At this stage or just before the start of the quiz the user can filter the list of questions (705) to be included in that particular session. A user can see the detailed analysis for the question (706).

Another option for the user is to search question across number of quizzes (710). This searching will create a list based on number of parameters (711). Optionally user can create a new question (712) if they don't like the one from the list. They can also tag the question with the meta-data (711) and make the selected questions or newly created question to be part of new Quiz/Test or be added to the existing Quiz/Test (715).

In the User Interaction flow of FIG. 7 only the core functionality is shown. The other functionality that a user will be able to perform but is not limited to is Frequently Asked Questions, Look for Resources, Participate in Discussion Groups, Chat with other participants, and similar other commonly known and available collaboration activities and other learning aids.

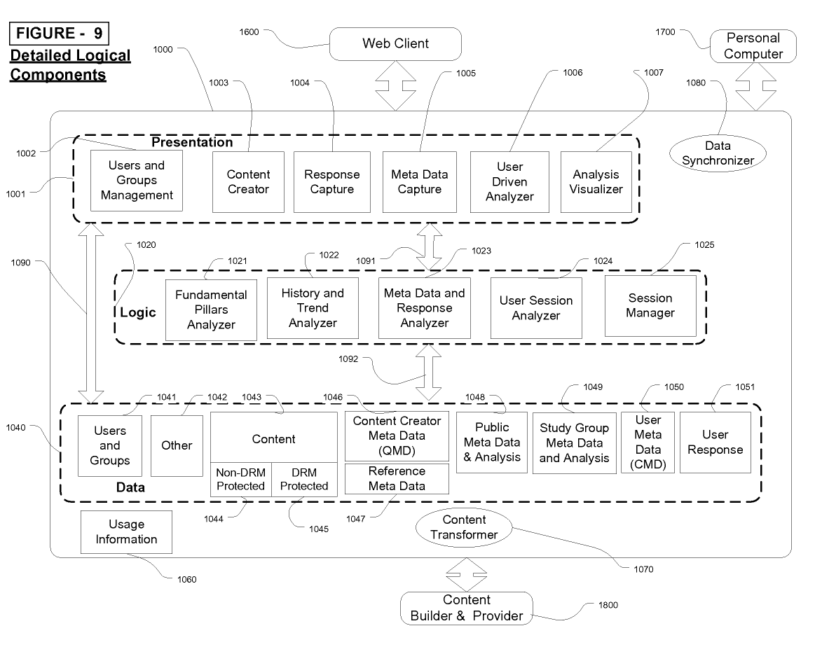

As shown in FIG. 8 the system can work in various modes. In one of the embodiment the content provider (the people who are expert in the art of creating Tests and Question for student assessments) can create the Question in the tool of their choice, and they can associate the QMD with each question as they are creating the Question. These questions along with QMD can be loaded into the system 1000 as shown and explained in FIG. 9 details. The external content provider data is transformed using 1070 and is persisted in the data Store of 1000. The content and the tagged Meta-Data will be persisted in data store 1040. Any party by leveraging web client (1600) can create the content and tagging. They can also tag the previously created or existing contents. They can also retag the existing information. A user with system installed with the software can also work in the offline mode (1700). In the offline mode the user can download subset of Tests/Questions to their personal machine via number of means from where they can practice, learn and tag the Questions and Tests. This information will be synced back to the server on the user initiative as described in later part of document.

As shown in FIG. 8, one of the embodiments of the system (1000) may consist of data storage (1040), content capture and presentation (1001), analytics engine (1020), data synchronization subsystem (1080) and content transformer (1070). All components 1000, 1001, 1020, 1080, 1070 and 1040 are described in greater detail in connection with FIG. 9.

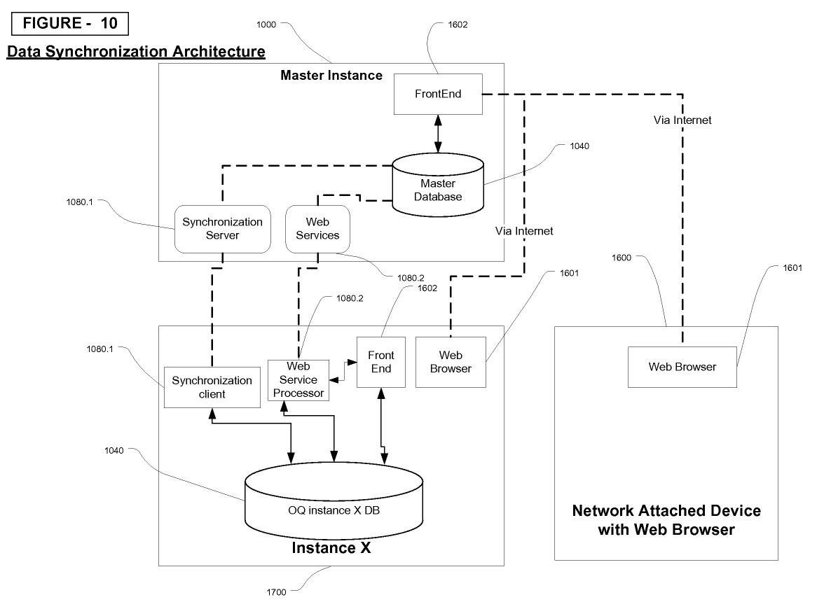

The external systems that will interact with 1000 are Web Clients (1600). The use of web technology is widely and publicly known. Using web client (web browser) a user will be able to interact with the components of 1000. The transmission of information for web client will take place leveraging standard technology and protocols which are widely available and in use. The personal computer is one on which an instance of 1000 can be executed, an example of this but not limited to is that a student may decide to do the study offline (not connected to any network). In this situation the student will install the instance of 1000 (full or partial) on their computer and will download the content on the 1700 database and will complete the session. After the session the user can synchronize the newly generated data from 1700 to master instance of 1000. The more detail of this is shown in the FIG. 10 description. The Content Build and Provider (1800) are the units that will transmit and exchange the content in bulk in different publicly known and widely used (example XML etc.) and other proprietary format. The content transformer (1070) will convert the content provider content to 1100 format and vice versa.

MMBL utilizes data structures that represent content knowledge, content data, knowledge model, learning data that can be for a class, group, school, enterprise or combination there of user response data, the tagging generated by content creator, student or any other user. The FIG. 9 demonstrates an embodiment of various components out of number of possible variations.

### Persistence

In an embodiment shown in FIG. 9, the data for various aspects of the system resides in grouping 1040. The various types of data that is persisted in 1041 are the users profile the group information, the hierarchy and the relationship between them. The actual content is represented and persisted by 1043, the content can be of two types one which is protected by Digital Rights Management (1045) and the other that is not protected (1044). The DRM content is the one for which the content dissemination and usage can be controlled. For all content there is a reference Meta-data (1047), this reference meta-data gives the meanings to the values in the system and helps in the analysis engines (1020) implementation. There is content meta-data (QMD) which persists in 1046.

As the user conducts the practice session there are two types of data that is captured. The actual answers the user has entered are saved in (1051) and the Meta-data (CMD) by user is saved in (1050).

As the peer group completes the sessions, the data is analyzed by various algorithms in 1020 and that analysis is persisted in Study group meta-data (1049). Additionally various analysis are performed on the cross peer group meta-data and responses which is persisted in 1048. The other type of data is maintained in the 1042. The example of other data includes user and group hierarchy, learning model etc.

There are a number of possible variations that can be applied for presentation of this system and methodology. In one of the embodiments as shown in the diagram, there is user interface for managing the users and its profile, the groups profile and members (1002). There is a screen that will capture the user responses for the questions and the corresponding time spent (1004), as well the interface that will capture the meta-data (CMD) (1005) associated with the question. This capturing can be for any type of Meta-data as described and listed in earlier sections. A user can also create new questions, answers and other contents via means of content creator module (1003). By means of analyzer (1006) a user can define the criteria for analysis which will be visualized via means of module Analysis Visualization (1007).

The module 1020 contains the logic and algorithms that are applied on the collected data from the presentation layers as well as created or entered during the content creation time. The module session manager (1025) keep track of the session for the user sessions. Some of the example information that is managed but is not limited to this is start time, number of questions answered etc. The user session Analyzer (1024) manages the analysis from different dimension of meta-data (QMD/CMD). The Meta Data Response and Analyzer (1023) compute the various results for the responses submitted by a user versus the various Meta-data dimensions. The module 1022, history and trend analyzer, computes and analyzes the trends for the student over a long period of time to identity the relative strengths and weakness for the students for various subjects. The three pillar analyzer (1011) analysis the data for a peer groups of student and analyzes the relative strengths and weakness for three pillars, that is, the relative performance of the Students, Contents that is used for learning and the Instructor who are involved.

Data synchronizer (1080) is the module that when an instance or the subset of 1000 is running on some other place (example an instance of 1000 is running on a personal computer for a user, or a full version of 1000 is running in an enterprise on other server), the data synchronizer module will synchronize the data between the master instance and secondary instance. This concept is described in more detail in the description of FIG. 10.

The Content Transformation Module (1070) is the one that will transform the content from various formats to the format and structure required by 1043. This transformer will be a two way converter that will take formats like, XML, excel, Comma Separated Files, Rich Text Format etc. but not limited to these and will convert into the format of 1043. While converting out, the data can be converted into any industry standard or proprietary format, including by not limited to SCORM, XML, plain text etc.

The module Usage Information 1060 is the one that will track the usage of the content, 1043 and also the usage by an individual user which may include but is not limited to as how many times a particular Test or Question was answered, or how many Tests an individual Student has taken.

There are number of possible ways in which the synchronization between two databases can be done. In an embodiment described here for illustration purpose only is as shown in FIG. 10. In this there is one instance of the system (1000) with a Master database instance (1040). All the services that operate within the context of 1000 as described in FIG. 9 are available via Front End (1602). These can be accessed via a Network attached device with a web browser (1600) which can be a mobile device, hand held device, a personal computer or any other device. The browser 1601 will access all the allowed information from Master Instance. There can also be another instance (1700) of full or partial system which may have some variation in configuration with respect to Master Instance. For example but not limited to is an user running an instance of 1000 on the personal computer. In this instance there will be a database (1040) which will have some additional information (1040).

In order to synchronize the data between the two instances of 1040 there will be a synchronization sub system (1080.1) that can play a role of client and server and will exchange and synchronize the data. The other mechanism can be the web services (1080.2) running on Master Instance and Instance X. An instance X (1700) can have a local instance as well a web browser (1601) to access the master instance.

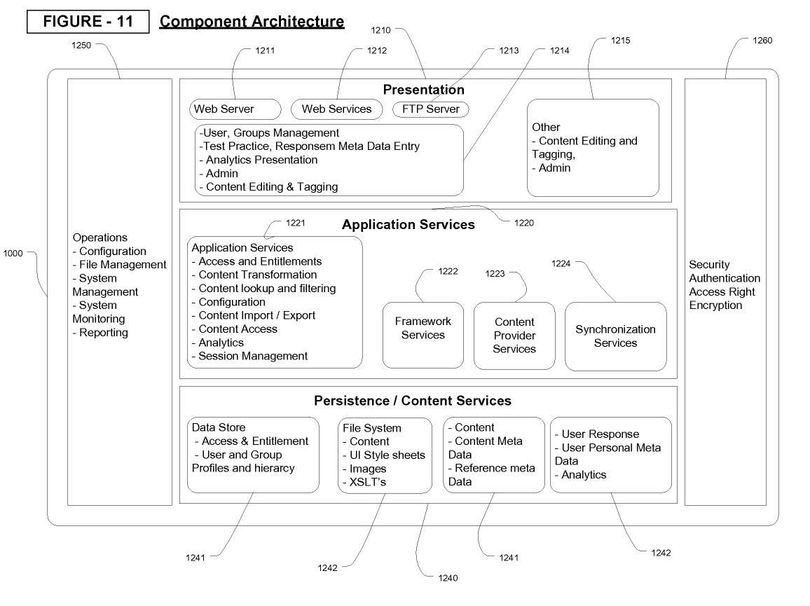

Another visualization of 1000 can be done by the technology tiers. There are number of other possible combinations possible, one of the possible embodiments is shown in FIG. 11 for illustration purposes only. The subsystem presentation (1210) can be any of the possible combinations. The components of functionality (1214) can be exposed and interact with the end user via leveraging Web Server (1211), Web Services (1212), FTP Server (1213). There can also be a client server based presentation component (1215).

The Application Services (1220) subsystem contains module for all application services (1221). The Framework Services (1222) module will provide services like database connectivity, web services etc. The Content Provider Services (1223) module will provide the data transformation services for bulk upload and download. The Synchronization Services (1224) module manages the data synchronization between the Master Instance of database with other instances of database as described in FIG. 10 description.

The Persistence/Content Services (1240) subsystem describes the possible way the data will be persisted. The user information and group profile will be persisted in 1241, which can be a relational database or other format. The file system (1242) will contain other type of information, example: graphics etc but not limited to it. The learning contents (1241) along with the QMD and reference meta-data will persist in 1241. The user responses, session information, CMD and analytics will persist in 1242. 1250 represents the operational management functionality of the system. 1260 represents the security and authorization subsystem that interacts with the other modules at all levels.

All User Interface screens referenced in these figures and described in this section are but one embodiment of a number of possible variations. They are shown here only to demonstrate the concept and in no way confine the functionality to what is shown or how it is shown on the screens. Current sample is shown for web based implementation screens.

For a sample web based implementation, FIG. 12a is the entry point, or the main page of system. This pace is an entry point to all types of users to the system. Some of the user types may be but not limited to are; students, teachers, parents, admin, content moderator, content provider etc. There are number of actions that each user can initiate from here and can access, such as study tools, collaboration tools, manage study groups, learning material and can practice or create Quizzes/Tests sessions. They can also access favorites or can do a quick navigation across the system using the main navigation bar 2004. The system has the capability to recognize users. In order to do so the user can click on the Login (2005). Which will open up the FIG. 12b where a user can login (2051) with their credentials or they can request an access account (2052).

FIG. 13 shows the list of Tests/Quizzes available to the user. A user can initiate a number of actions on the Test/Quiz. Clicking on 2101 shows more details about the Test and opens the screen shown in FIG. 14. Clicking on 2103 starts the Test Session for a Test/Quiz. Clicking on 2105 will open up the Question List page (FIG. 15a) for a single Test. A User can also select a number of rows and click on 2102 to see the Question List from multiple Tests. A User can also initiate Test session for questions from multiple Tests by selecting number of Tests and clicking on 2104. The selection of multiple rows is done by marking the checkbox 2106.

FIG. 14 show the details for a Quiz/Test that was selected on the Quiz/Test List or on the Test/Quiz List page.

### FIG. 15a-15c—Question List

FIGS. 15a-15c show various question Lists. FIG. 15a shows the abbreviated (if the question is too large to fit in the limited space) description list along with few other details for the question from the Test(s) that were selected prior to opening this page. There are number of views of Question List. By default the user will see the FIG. 15a—Question List—QMD. Here lot of static data associated which each question is shown in tabular form. If the user wants to practice or review only subset of question from the list, they can do by using the Filter 2302 which allows users to define various criteria for filtering.

FIG. 15b shows the Question List with user CMD, here all the tagging that was completed the user shows up. The user can use 2303 to define the criteria for CMD and further filter the question list.

FIG. 15c shows the Question List with user response history; here all the responses that were given by the user for the selected Test questions are shown. The user can use 2304 to define the criteria and further filter or search for questions.

In all figures, the user can select the subset of questions from the list and click on 2301 to initiate a Test practice session. The user can also combine the criteria across various pages to create very interesting and powerful learning sessions instantaneously which other wise would have taken significant amount of time.

### FIG. 16—Question Detail/Take Test

FIG. 16 shows the details of the Question. Depending on the mode in which the user is coming on this screen (some of the examples of the various modes includes review mode, reading mode, test practice mode, test mode etc. but are not limited to these only) a user is allowed to do different combinations of actions. Assuming a mode where user can enter the answer, the user enter responses for each question, they can click ‘Next’ (2402) to move on the next question. As the user clicks the “Next” 2402, the system tracks the amount of time the user has spent on each question. If applicable, user can go back to question by clicking the previous button (2403). This screen also has the place where user can enter the comment (2406). This screen also has QMD data center (2407) as well CMD center (2408). CMD is described in FIG. 17.

FIG. 17 includes everything from FIG. 16. Additionally 2408 is the place where user can use the CMD. Some of the CMD elements are shown for example purpose only which includes Difficulty (2409), Importance (2410), Grasp (2411) and I'm Feeling (2412). Other elements can be configured to be shown here. User can enter the CMD information for each shown data element as well enters free form text or tags in 2413.

When user completes the test on FIG. 16/FIG. 17, the user is presented with FIG. 18a. This screen presents the quick Test Result as well as allows the user to launch and see more detailed analysis reports and recommendations. The user can initiate number of actions from this page. 2551 represents the summary results for session with breakdown of score into correct, incorrect (wrong), skipped and left-over category. A User can start the review of session for any combinations of results from 2551 by selecting that criteria and clicking on 2553. A User also gets to see the quick ‘Self Assessment’ in 2552. This shows the user expectation of score before starting the Test session, expectation of score after completing the Test session but before the system actually analyzed the results and finally the actual score achieved by the user.

There are various detailed reports and recommendation available to the student. One of the examples is Result Analysis by QMD and CMD dimensions (FIG. 18b) that a user can open by clicking on 2554.

The screen shown in FIG. 18b presents the test result metric to the user in number of possible ways. Example analysis is shown here for demonstration purpose only, but is not limited to this. The 2501 shows the student response breakdown by means of QMD elements. For example 2502 shown the user response breakdown of a 100 question test by a ‘Question Type’, ‘Question Objective’ and ‘Topic’ breakdown. These three elements are shown as an example. This list can be configurable and any number of elements can be shown here. The 2503 shows the student response breakdown by means of CMD elements (2503). For example 2504 show test response breakdown by ‘Difficulty’, and ‘Confidence’.

Additionally the user can click on any of the numbers which are shown as part of the breakdown. For example, a user can click on 2507 and the user will be presented with a test that will contain 10 questions out of 1100 marked by user as medium complexity and were responded incorrectly during the session by user.

Based, on MMBL methodology the user practice results and knowledge level can be analyzed and presented in different views as shown in FIG. 19a (2600). Four analysis examples are shown here for demonstration purpose. 2601 shows the relative analysis for multiple subjects. 2621 shows the subtopic analysis for one of the subjects. 2641 shows the knowledge and learning trends for various subjects over period of time. 2661 shows the user learning status by different types of question objectives.

FIG. 19b illustrates a Learning Summary Dashboard which can be presented to a user. 2650 shows a quick summary of effort and result for a Learner/Student. The information is presented in various modes which provide statistics and analysis. Three examples that are shown in 2650 are: Testing Stats (2651), Overall Response Stats for all questions responded (2652), Performance over time for the most recent 5 sessions (2653). More modes of display can be added by selecting from a pool of display elements by clicking on 2654.

All database tables referenced in the following figures and described in this sections and this application in general is one embodiment of a number of possible variations. They are shown here only to demonstrate the concept and in no way confine the functionality or how it should be implemented since someone skilled in the art would appreciate how to implement such a database table and structure.

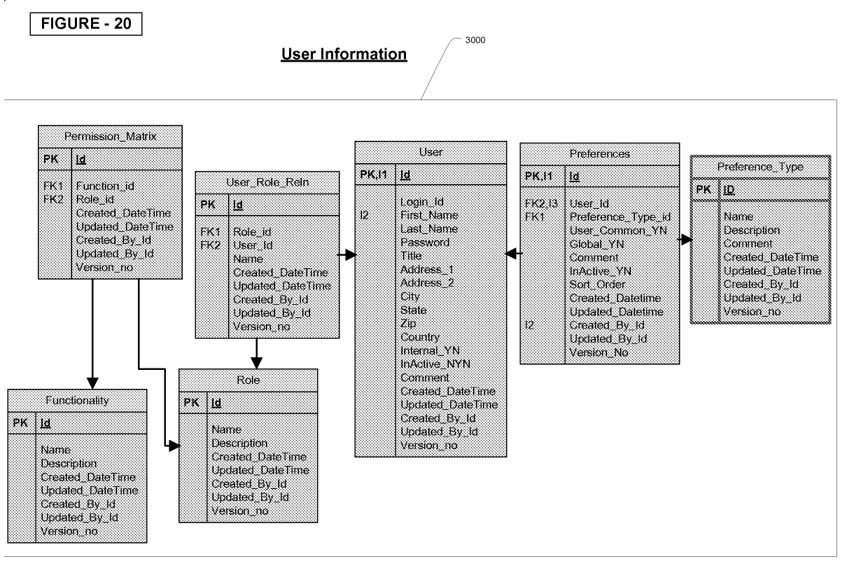

FIG. 20—Data base tables for Users: This figure shows one possible way to implement user, roles, security and preferences to be stored in the relational database.

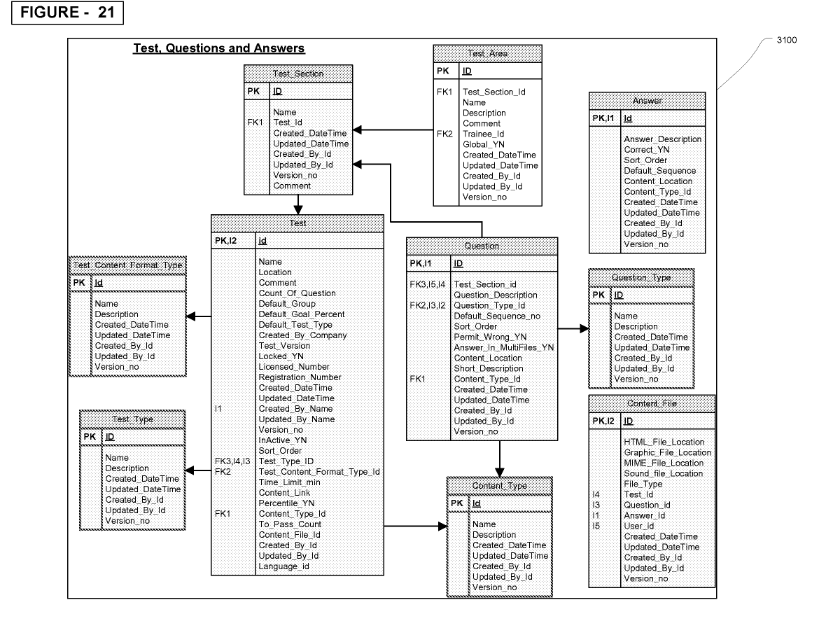

FIG. 21—Data base tables for Test, Question and Answers: This figure shows one possible way to implement how the contents i.e. questions, answers and tests can be stored in the relational database.

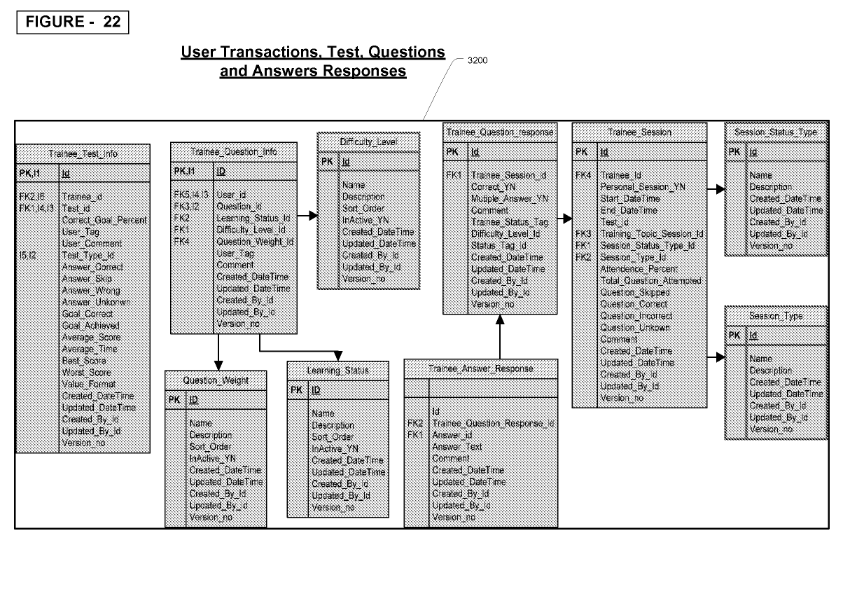

FIG. 22—Data base tables for user response and meta-data: This figure shows one possible way to implement how the user response to questions including the CMD can be stored in the relational database.

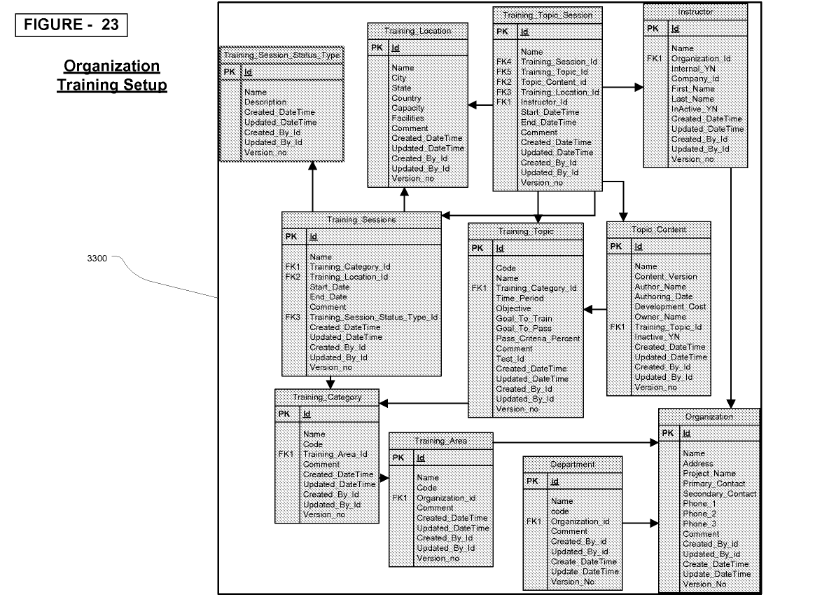

FIG. 23—Data base tables for training setup: This figure shows one possible way to implement how the organization and groups setting can be stored in the relational database.

### Meta-Data and Metrics Based Learning

The ability to identify a Learner's/Student's learning strengths and weakness, and present concepts within the context and format a student feels most comfortable is attuned to overcomes the deficiencies of both conventional classroom, current personal and internet-based test preparation and other existing learning methodology and systems. One specific technological embodiment of this approach is known as the MMBL (Meta-data and Metrics Based Learning) which is illustrated in the block diagram of FIG. 1.

Foundational research on the human brain and effective learning combined with recent advances in computer communications, network programming, internet and peer to peer based data collection and intelligent systems theory provide a technological foundation upon which MMBL is based, resulting in a system that can provide wide-spread access to improved education quality.

The basis for this approach is derived from the results of numerous empirical studies into learning performance conducted over the past number of decades.

The results of that research can be summarized by following tenets:

Current learning processes, entrenched in teachers and students mind are highly inefficient. There is tremendous amount of friction that an individual has to overcome while doing the learning in particular for the standardize tests where majority of questions are non-descriptive. As a result students waste significant amount of time evaluating where they should spend their time or they actually spent the time on relatively less important issues.

Every person has natural inclination and strength for a particular topic. The decision for career/next jobs is made based on most recent assessment (grades/certification) information, overlooking the fact, that area may not be the natural competency and strength of an individual. As a result, the learner/student will take the assignment based on most recent score but the productivity remains low, the student remains frustrated because of non-natural inclination towards the topic and the extra efforts they need to put up and ends up switching major/career mid-way college/professional life and waste time, money and energy.

Whenever a student is falling behind in a topic the natural tendencies for the student is to work hard and or change the instructor resulting some time in improvements in results. Currently there is no objective measure of which pillar of learning needs improvement, and as a result, a student either changes instructor mid-way or works extra hard, with only marginal and temporary improvement in grades. Having an understanding about fundamental pillars of learning and not always blaming themselves removes a tremendous pressure from the student, which in turn translates into investing energy and effort at the right place.

The process of education is enhanced for a particular individual when the information is communicated in a form that is compatible with that individual's natural strength and weakness and learning pace.

An individual's performance and retention is directly and dramatically increased when the information is available and has the possibility to be presented that is aligned with the individual learning pace, attitude and aptitude.

In addition to these research results, empirical observation in classroom teaching environments has lead to a general acknowledgment of the desirability of accommodating different learning styles and of the superiority of one-on-one instruction over conventional classroom teaching approaches in adapting to the needs and maximizing the learning of the individual pupil.

Research on the effect of differing learning styles and having a understanding of all pillars of learning has existed for over number of years in various forms, but has failed to make any significant impact in the way education is implemented and executed. These research are also utilized at level by education policy maker in a generic way, where they will try to find the pattern and trends but with the limited transparency of underlying data, and ultimately the student who is at the center of all this have limited correlation of their individual performance with reference to the rest of the groups they work with.

Once the existence and importance of differing learning styles was empirically documented, the researchers turned their attention to attempting to identify broad categories of learning styles and finding predictive instruments that would allow educators to identify learners as members of a particular learning style category. Research hoped that the identification of broad categories of learning styles and development of associated predictive instruments would allow students of similar learning capabilities to be grouped together, thereby making it possible for each group to receive information in an optimum form. Unfortunately, researchers were largely unsuccessful at empirically validating any definitive categorizations of learning styles although a number of competing categorizations were investigated. Further, they were unable to demonstrate the effectiveness of predictive testing instruments for assigning individuals to specific categories. MMBL employs the techniques where each student can customize their learning and test preparation session that are most suitable to their needs.

The invention is the result of research into why does individualized and customizable presentation and MMBL methodology result in such a dramatic increase in learning performance and retention? The key lies in following characteristics of individualized instruction that differentiates it from conventional learning approaches:

(1) The knowledge is presented in a way how an individual wants to see and learns (2) the student is a participant in the learning process with in the confine of the contents provided by the instructor; (3) the learning outcome is highly analytic, metric based, and adaptive to the needs of an individual; (4) the student is provided with immediate feed back; (5) The student continues to evolve his/her understanding about his strength and weakness with in the context of his/her overall knowledge base and can see the trends; and (6) The student has the ability to develop understanding of his/her knowledge based with in the context of their peer group as well as the public in general.

This assertion is empirically validated by the increase in learner performance relative to decreased class size and more specifically by having a one on one tutoring and by having the human analyzer on hand. As the size of the group decreases the opportunities for each tutor to understand and analyze an individual student pattern and remove the friction on student behalf increases. As the friction of analyzing goes away the student is able to focus more on the learning and retaining the knowledge rather figuring out where they need to spend the time. Additionally a student doing better with another teacher or a private tutor endorses the fact that the original instructor or content potentially has something to do with the student not being able to grasp and learn, but in current context there is no quantifiable way to emphasize that.

With the advent of the internet as an interactive ubiquitous information channel, as well as the ability to synchronize the information either with the peer group or with the centralized system via various publicly know techniques has created the possibility for an opportunity to revolutionize the educational and learning process.

By developing a learning paradigm that adapts and allows the student to customize it to the learning style of an individual, and provides a high interactive and analytical environment, a continuous reference to learner strengths, reference with their peer group and reference to outside the peer group, and to have the understanding of fundamental pillars makes the student a participant in the process with deep and quantifiable understanding that allow student to focus at the right place with the right effort. In essence the effectiveness of the educational process from all three pillar perspective is improved.

At the same time, by removing from the human instructors the onerous task of being the broadcasters of information and analyzer of huge amount of data generated by students, they are free to focus on those aspects of instruction that are best facilitated by human interaction and mentoring.

In order for computer-based and internet-based training to realize the promise of individualized instruction it takes more than just converting existing course notes and hard copy documentation into Hyper Text Mark-up Language (“HTML”). Most of the current training classes available on the web today are little more than electronic textbooks. While putting static content on the web does offer advantages in the areas of knowledge maintenance and distribution, such a “one-size-fits-all” approach to instruction falls far short of the potential impact that individualized web-based learning can offer.

The present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

1. A system for assisting users to learn the subject matter, comprising:
means for presenting one or more test questions to a user;
means for receiving an answer to said one or more test questions presented to said user;
means, responsive to said received answer to said one or more test questions, for collecting metadata associated with said one or more test questions and/or said answer to said one or more test questions; and
means, responsive to said metadata, configured for providing said user with a report indicative of at least the user's understanding of said one of more questions asked and/or answered by said user.

2. The system of claim 1, wherein each of said one or more test questions includes associated question metadata.

3. The system of claim 1, wherein said subject matter includes test metadata.

4. The system of claim 1, wherein said metadata is selected from the group of metadata consisting of test metadata, question metadata, question response data and cognitive metadata.

5. The system of claim 1, wherein said report provides the user with one or more areas of understanding selected from the group consisting of: understanding of the subject area being tested; the users learning style; the users study style; the users lack of knowledge of a subject area; other information needed by the user to increase his or her learning capacity and ability, ability; and a information needed by the user to decrease his or her learning time.

6. A system for assisting users to learn the subject matter, comprising:
a presentation device, for presenting one or more test questions to a user;
an answer receiver, for receiving an answer to said one or more test questions presented to said user;
a metadata collector, responsive to said received answer to said one or more test questions, for collecting metadata associated with said one or more test questions and/or said answer to said one or more test questions; and
a report generator, responsive to said metadata, configured for providing said user with a report indicative of at least the user's understanding of said one of more questions asked and/or answered by said user.

7. The system of claim 6, wherein each of said one or more test questions includes associated question metadata.

8. The system of claim 6, wherein said subject matter includes test metadata.

9. The system of claim 6, wherein said metadata is selected from the group of metadata consisting of test metadata, question metadata, question response metadata and cognitive metadata.

10. The system of claim 6, wherein said report provides the user with one or more areas of understanding selected from the group consisting of: understanding of the subject area being tested; the users learning style; the users study style; the users lack of knowledge of a subject area; other information needed by the user to increase his or her learning capacity and ability, ability; and a information needed by the user to decrease his or her learning time.

11. A method for assisting users to learn the subject matter, comprising the acts of:
presenting one or more test questions to a user;
receiving an answer to said one or more test questions presented to said user;
responsive to said received answer to said one or more test questions, collecting metadata associated with said one or more test questions and/or said answer to said one or more test questions; and
responsive to said collected metadata, providing said user with a report indicative of at least the user's understanding of said one of more questions asked and/or answered by said user.

12. The method of claim 11, wherein each of said one or more test questions includes associated question metadata.

13. The method of claim 11, wherein said subject matter includes test metadata.

14. The method of claim 11, wherein said metadata is selected from the group of metadata consisting of test metadata, question metadata, question response metadata and cognitive metadata.

15. The method of claim 11, wherein said report provides the user with one or more areas of understanding selected from the group consisting of: understanding of the subject area being tested; the users learning style; the users study style; the users lack of knowledge of a subject area; other information needed by the user to increase his or her learning capacity and ability, ability; and a information needed by the user to decrease his or her learning time.

16. The method of claim 11, wherein said report provides the user with one or more areas of understanding that allows the user to identify and define learning strategies, and identify content that will help reduce learning time for student.

17. The method of claim 11, wherein said metadata includes question response metadata.

18. The method of claim 17 wherein said question response metadata is obtained from said user.

19. The method of claim 17 wherein said question response metadata is obtained from said user's peer group.
